(19) United States
(12) Patent Application Publication
(10) Pub. No.: US 2008/0080097 A1
(43) Pub. Date: Apr. 3, 2008

(54) MAGNETORESISTIVE ELEMENT, METHOD OF MANUFACTURING THE SAME, AND MAGNETIC STORAGE UNIT

(75) Inventor: Keiichi NAGASAKA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/851,062

(22) Filed: Sep. 6, 2007

(30) Foreign Application Priority Data
Sep. 28, 2006 (JP) 2006-265383

(51) Int. Cl. G11B 5/33

(52) U.S. Cl. 360/314

(57) ABSTRACT

A magnetoresistive element is disclosed that includes first and second terminals provided on first and second opposing surfaces, respectively, of a magnetoresistive film; the magnetoresistive film including a fixed magnetization layer, a non-magnetic metal layer, and a free magnetization layer stacked in this order from the first terminal side; and a first magnetic coupling interruption layer covering the free magnetization layer and a second magnetic coupling interruption layer covering the first magnetic coupling interruption layer provided between the magnetoresistive element and the second terminal. The first magnetic coupling interruption layer includes a first non-magnetic material causing spin-dependent interface scattering. The second magnetic coupling interruption layer includes a second non-magnetic material different from the first non-magnetic material, the second non-magnetic material containing at least one selected from the group consisting of Al, Ti, Cr, Mn, Zn, Nb, Mo, Ru, Rh, Pd, Ag, In, Hf, Ta, W, Ir, Pt, and Au.

### CROSS-REFERENCE TO RELATED APPLICATION

The present application is based on Japanese Priority Patent Application No. 2006-265383, filed on Sep. 28, 2006, the entire contents of which are hereby incorporated by reference.

### BACKGROUND OF THE INVENTION

1. Field of the Invention

The present invention relates generally to magnetoresistive elements for reproducing information in a magnetic storage unit, methods of manufacturing the same, and magnetic storage units, and more particularly to a magnetoresistive element having a CPP (Current-Perpendicular-to-Plane) structure where sense current is caused to flow perpendicularly to the stacked films forming the magnetoresistive element, a method of manufacturing the same, and a magnetic storage unit including the same.

2. Description of the Related Art

In recent years, in the magnetic head of a magnetic storage unit, a magnetoresistive element has been employed as a reproduction element for reproducing information recorded in a magnetic recording medium. The magnetoresistive element reproduces information recorded in the magnetic recording medium using the magnetoresistance effect that converts a change in the direction of a signal magnetic field leaking out (emanating) from the magnetic recording medium into a change in electric resistance.

With the increase in the recording density of the magnetic storage unit, magnetoresistive elements with a spin-valve film have become mainstream. The spin-valve film includes has stacked layers of a fixed magnetization layer in which magnetization is fixed in a predetermined direction, a non-magnetic layer, and a free magnetization layer in which the direction of magnetization changes in accordance with the direction and the strength of a leakage magnetic field from a magnetic recording medium. The electric resistance of the spin-valve film changes in accordance with the angle formed by the magnetization of the fixed magnetization layer and the magnetization of the free magnetization layer. The magnetoresistive element reproduces bits recorded in the magnetic recording medium by detecting a change in the electric resistance as a change in voltage by causing a sense current of a fixed value to flow through the spin-valve film.

Conventionally, a CIP (Current-In-Plane) structure where sense current is caused to flow in the in-plane direction of a spin-valve film has been employed for the magnetoresistive element. In order to achieve a further increase in the recording density, however, it is necessary to increase the line recording density and track density of the magnetic recording medium. In the magnetoresistive element, it is necessary to reduce both element width corresponding to the track width of the magnetic recording medium and element depth (the height of the element), that is, the element cross section. In this case, in the CIP structure, the current density of sense current increases so that degradation of performance may be caused by the migration of material forming the spin-valve film due to overheating.

Therefore, a CPP structure where sense current is caused to flow perpendicularly to the surface of the spin-valve film has been proposed and studied eagerly as a next-generation reproduction element. The CPP-type magnetoresistive element, which is characterized in that a reduction in the core width (the width of the spin-valve film corresponding to the track width of a magnetic recording medium) hardly changes output, is suitable for increasing recording density. (See Japanese Laid-Open Patent Application No. 2003-318461.)

As shown in FIG. 1, a CPP-type magnetoresistive element 100 has a spin-valve film 101 sandwiched between a lower terminal 102 and an upper terminal 103 also serving as magnetic shields. The spin-valve 101 has an underlayer 111, an antiferromagnetic layer 112, a fixed magnetization layer 113, a non-magnetic conductive layer 114, and a free magnetization layer 115 from the lower terminal 102 side. The spin-valve film 101 further includes a protection film 104 formed to cover the free magnetization layer 115.

The free magnetization layer 115 of the spin-valve film 101 detects the direction of a signal magnetic field that passes through the region sandwiched between the lower terminal 102 and the upper terminal 103. The shorter is the distance between the upper surface of the lower terminal 102 and the lower surface of the upper terminal 103, or so-called read gap length, the finer is a detectable change in the signal magnetic field. Accordingly, a shorter read gap length is suitable for high-density recording.

The lower terminal 102 and the upper terminal 103, which are formed of a soft magnetic material, serve as the magnetic shields of the spin-valve film 101. That is, the lower terminal 102 and the upper terminal 103 prevent magnetic fields from the magnetic poles and coil of a recording element from magnetizing the fixed magnetization layer 113 and the free magnetization layer 115 of the spin-valve film 101 and exerting an adverse effect.

On the other hand, the upper terminal 103 and the free magnetization layer 115 are closely provided so that it is easy for them to be magnetically coupled. Therefore, the protection film 104 is disposed between the free magnetization layer 115 and the upper terminal 103 so as to interrupt their magnetic coupling.

A reduction in the read gap length improves reproduction output and SN ratio (signal-to-noise ratio) at high recording density, thus making it possible to further increase recording density.

However, a simple reduction in the thickness of the protection film 104 shown in FIG. 1 for reducing the read gap length causes the magnetization Ma of the free magnetization layer 115 and a magnetization M_{EL} appearing in the upper terminal 103 to be magnetically coupled. In this condition, the behavior of the magnetization Ma of the free magnetization layer 115 with respect to a signal magnetic field becomes less responsive or biased. This causes a problem in that the reproduction output is distorted so as to reduce the SN ratio.

### SUMMARY OF THE INVENTION

According to one embodiment of the present invention, there is provided a magnetoresistive element in which a sense current is fed in a direction perpendicular to a film plane of a magnetoresistive film, the magnetoresistive element including a first terminal and a second terminal provided on first and second opposing surfaces, respectively, of the magnetoresistive film, the first and second terminals each being formed of a soft magnetic material; the magnetoresistive film including a fixed magnetization layer, a non-magnetic metal layer, and a free magnetization layer stacked in this order from a side of the first terminal; and a first magnetic coupling interruption layer covering the free magnetization layer, and a second magnetic coupling interruption layer covering the first magnetic coupling interruption layer, the first and second magnetic coupling interruption layers being provided between the magnetoresistive element and the second terminal, wherein the first magnetic coupling interruption layer includes a first non-magnetic material causing spin-dependent interface scattering; and the second magnetic coupling interruption layer includes a second non-magnetic material different from the first non-magnetic material, the second non-magnetic material containing at least one selected from the group consisting of Al, Ti, Cr, Mn, Zn, Nb, Mo, Ru, Rh, Pd, Ag, In, Hf, Ta, W, Ir, Pt, and Au.

According to one embodiment of the present invention, there is provided a magnetoresistive element in which a sense current is fed in a direction perpendicular to a film plane of a magnetoresistive film, the magnetoresistive element including a first terminal and a second terminal provided on first and second opposing surfaces, respectively, of the magnetoresistive film, the first and second terminals each being formed of a soft magnetic material; the magnetoresistive film including a fixed magnetization layer, a non-magnetic layer, and a free magnetization layer stacked; and a magnetic coupling interruption layer provided between the magnetoresistive element and the second terminal, wherein the magnetic coupling interruption layer includes Ta, and has a film thickness in a range of 0.9 nm to 5 nm.

According to one embodiment of the present invention, there is provided a method of manufacturing a magnetoresistive element in which a sense current is fed in a direction perpendicular to a film plane of a magnetoresistive film, the method including the steps of: (a) forming the magnetoresistive film on a first terminal; (b) forming a first magnetic coupling interruption layer and a second magnetic coupling interruption layer in this order on the magnetoresistive element, the first and second magnetic coupling interruption layers each including a non-magnetic material; and (c) forming a second terminal in contact with a surface of the second magnetic coupling interruption layer, wherein the first magnetic coupling interruption layer covers a free magnetization layer of the magnetoresistive film and includes a first non-magnetic material causing spin-dependent interface scattering; and the second magnetic coupling interruption layer includes a second non-magnetic material different from the first non-magnetic material, the second non-magnetic material containing at least one selected from the group consisting of Al, Ti, Cr, Mn, Zn, Nb, Mo, Ru, Rh, Pd, Ag, In, Hf, Ta, W, Ir, Pt, and Au.

According to one embodiment of the present invention, there is provided a method of manufacturing a magnetoresistive element in which a sense current is fed in a direction perpendicular to a film plane of a magnetoresistive film, the method including the steps of: (a) forming the magnetoresistive film on a first terminal; (b) forming a magnetic coupling interruption layer including a non-magnetic material, and a soft magnetic protection film including a soft magnetic material in this order on the magnetoresistive element; (c) performing heat treatment on the magnetoresistive film, the magnetic coupling interruption layer, and the soft magnetic protection film; (d) removing a part of the soft magnetic protection film; and (e) forming a second terminal covering a surface of the soft magnetic protection film exposed by step (d), wherein the magnetic coupling interruption layer includes at least one selected from the group consisting of Al, Ti, Cr, Mn, Zn, Nb, Mo, Ru, Rh, Pd, Ag, In, Hf, Ta, W, Ir, Pt, and Au.

According to one embodiment of the present invention, there is provided a magnetic storage unit including a magnetic head having any of the above-described magnetoresistive elements; and a magnetic recording medium.

### BRIEF DESCRIPTION OF THE DRAWINGS

Other objects, features and advantages of the present invention will become more apparent from the following detailed description when read in conjunction with the accompanying drawings, in which:

FIG. 1 is a diagram for illustrating problems of a conventional magnetoresistive element;

FIG. 2 is a diagram showing part of the medium opposing surface of a magnetic head including a first example magnetoresistive element according to a first embodiment of the present invention;

FIG. 3 is an enlarged view of part of the first example magnetoresistive element according to the first embodiment of the present invention;

FIGS. 4A through 4F are diagrams showing a method of forming the first example magnetoresistive element according to the first embodiment of the present invention;

FIG. 5 is a diagram showing part of the medium opposing surface of a second example magnetoresistive element according to the first embodiment of the present invention;

FIG. 6 is a diagram showing part of the medium opposing surface of a third example magnetoresistive element according to the first embodiment of the present invention;

FIGS. 7A and 7B are diagrams showing a method of forming the third example magnetoresistive element according to the first embodiment of the present invention;

FIG. 8 is a diagram showing part of the medium opposing surface of a fourth example magnetoresistive element according to the first embodiment of the present invention;

FIG. 9 is a diagram showing part of the medium opposing surface of a fifth example magnetoresistive element according to the first embodiment of the present invention;

FIG. 10 is a cross-sectional view of a first variation of a magnetoresistive film according to the first embodiment of the present invention;

FIG. 11 is a cross-sectional view of a second variation of the magnetoresistive film according to the first embodiment of the present invention;

FIG. 12A is a graph showing the relationship between an exchange coupling magnetic field and the film thickness of a magnetic coupling interruption layer of each of Examples 1-1 through 1-3 and 2 and Comparative Example 1 according to the first embodiment of the present invention;

FIG. 12B is a graph scaling up the vertical axis of FIG. 12A according to the first embodiment of the present invention;

FIG. 13 is a graph showing the relationship between magnetoresistance ratio and the film thickness of a first magnetic coupling interruption layer of each of Example 3 and Comparative Example 2 according to the first embodiment of the present invention;

FIG. 14 is a graph showing the relationship between an exchange coupling magnetic field and the film thickness of a magnetic coupling interruption layer of each of Example 4 and Comparative Example 3 according to the first embodiment of the present invention; and

FIG. 15 is a plan view of part of a magnetic storage unit according to a second embodiment of the present invention.

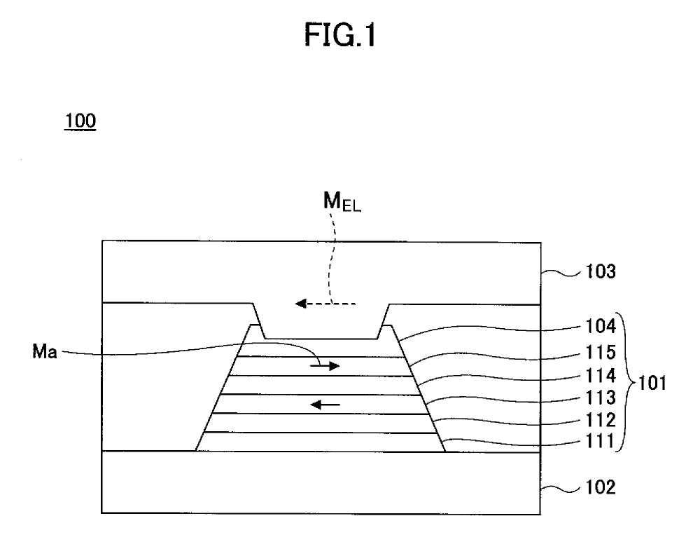

### DETAILED DESCRIPTION OF THE PREFERRED EMBODIMENTS

A description is given, with reference to the accompanying drawings, of embodiments of the present invention.

### First Embodiment

### First Example Magnetoresistive Element

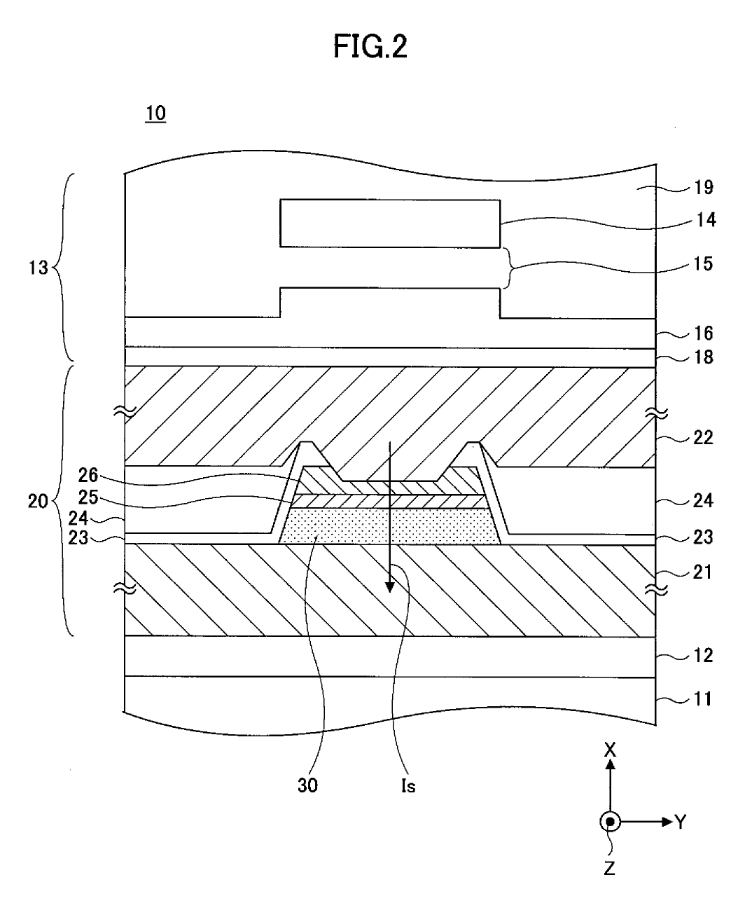

FIG. 2 is a diagram showing part of the medium opposing surface of a magnetic head 10 including a first example magnetoresistive element 20 according to a first embodiment of the present invention. The medium opposing surface refers to a surface that opposes a magnetic recording medium (not graphically illustrated). In FIG. 2, the X-axial directions are directions in which the magnetic recording medium moves relative to the magnetoresistive element 20, the Y-axial directions are the directions of core width, and the Z-axial directions are the directions of depth (element height).

Referring to FIG. 2, the magnetic head 10 includes the magnetoresistive element 20 and an induction-type recording element 13 formed thereon. The magnetoresistive element 20 is formed on a flat ceramic substrate 11 of Al₂O₃—TiC or the like serving as the base of a head slider.

The induction-type recording element 13 includes an upper magnetic pole 14, a lower magnetic pole 16, a yoke (not graphically illustrated) magnetically connecting the upper magnetic pole 14 and the lower magnetic pole 16, and a coil (not graphically illustrated) wound around the yoke to induce a recording magnetic field with recording current. The upper magnetic pole 14 has a width corresponding to the track width of the magnetic recording medium on the medium opposing surface. The lower magnetic pole 16 opposes the upper magnetic pole 14 across a recording gap layer 15 formed of a non-magnetic material. Each of the upper magnetic pole 14, the lower magnetic pole 16, and the yoke is formed of a soft magnetic material, which may be a material having high saturation flux density, such as Ni₈₀Fe₂₀, CoZrNb, FeN, FeSiN, FeCo, or CoNiFe, in order to ensure a sufficient recording magnetic field. The induction-type recording element 13 is not limited to this configuration, and an induction-type recording element of a known structure may be employed.

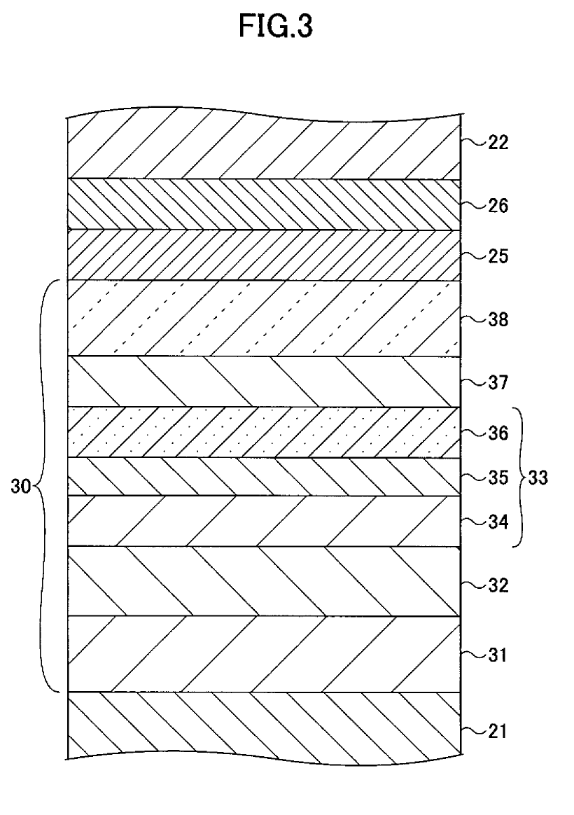

The magnetoresistive element 20 has a lower terminal 21, a magnetoresistive film 30 (described in detail below with reference to FIG. 3), a first magnetic coupling interruption layer 25, a second magnetic coupling interruption layer 26, and an upper terminal 22 stacked on an alumina film 12 formed on the surface of the ceramic substrate 11. The magnetoresistive film 30 is electrically connected to the lower terminal 21 and to the upper terminal 22 (through the first and second magnetic coupling interruption layers 25 and 26).

A magnetic domain control film 24 is provided on each side of the GMR film 30 in the Y-axial directions with an insulating film 23 provided therebetween. The magnetic domain control film 24 is formed of a layered body of, for example, a Cr film and a ferromagnetic CoCrPt film. The magnetic domain control film 24 converts a free magnetization layer 38 (FIG. 3) of the magnetoresistive film 30 into a single magnetic domain, and prevents generation of Barkhausen noise.

The lower terminal 21 and the upper terminal 22 function as a magnetic shield as well as the channel of a sense current Is. Therefore, each of the lower terminal 21 and the upper terminal 22 is formed of a soft magnetic material containing at least one of Co, Ni, and Fe, such as Ni₈₀Fe₂₀, CoZrNb, FeN, FeSiN, FeCo, or CoNiFe. Further, a conductive film such as a Cu film, Ta film, or Ti film may be provided at the interface between the lower terminal 21 and the magnetoresistive film 30.

Further, each of the magnetoresistive element 20 and the induction-type recording element 13 except for its medium opposing surface is covered with an alumina film or a carbon hydride film for prevention of corrosion.

The sense current Is flows, for example, from the upper terminal 22 to go through the second magnetic coupling interruption layer 26, the first magnetic coupling interruption layer 25, and the magnetoresistive film 30 substantially perpendicularly to its film surface so as to reach the lower terminal 21. The electric resistance, or so-called magnetoresistance, of the magnetoresistive film 30 changes in accordance with the strength and the direction of a signal magnetic field leaking out from the magnetic recording medium. The magnetoresistive element 20 causes the sense current Is of predetermined amperage to flow through the magnetoresistive film 30, thereby detecting a change in the magnetoresistance of the magnetoresistive film 30 as a voltage change. In this manner, the magnetoresistive element 20 reproduces information recorded in the magnetic recording medium. The direction in which the sense current Is flows is not limited to the direction shown in FIG. 2, and may be reversed. Further, it is also possible to detect a change in the magnetoresistance as a voltage change by applying a predetermined constant voltage to the magnetoresistive film 30.

In FIG. 2, each of reference numerals 18 and 19 denotes an alumina film.

FIG. 3 is an enlarged view of part of the magnetoresistive element 20, showing a layer structure around the magnetoresistive film 30.

Referring to FIG. 3 as well as FIG. 2, the magnetoresistive film 30 includes an underlayer 31, an antiferromagnetic layer 32, a fixed magnetization layered body 33, a non-magnetic metal layer 37, and a free magnetization layer 38, which are stacked successively from the lower terminal 21 side. The magnetoresistive film 30 has a so-called single spin-valve structure.

The underlayer 31 is formed on the surface of the lower terminal 21 by a method such as sputtering. The underlayer 31 is formed of, for example, a NiCr film or a layered body of a Ta film (for example, 5 nm in film thickness) and a NiFe film (for example, 5 nm in film thickness). Preferably, the Fe content of the NiFe film falls within the range of 17 at. % to 25 at. %. Employment of a NiFe film of such a composition causes the antiferromagnetic layer 32 to grow epitaxially on a crystal surface of (111), which is the crystal growth direction of the NiFe film, and the surface of a crystal surface crystallographically equivalent thereto. As a result, it is possible to improve the crystallinity of the antiferromagnetic layer 32.

The antiferromagnetic layer 32 is formed of, for example, a Mn-TM alloy of 4 nm to 30 nm (preferably, 4 nm to 10 nm) in film thickness, where TM includes at least one selected from Pt, Pd, Ni, Ir, and Rh. Examples of the Mn-TM alloy include PtMn, PdMn, NiMn, IrMn, and PtPdMn. The antiferromagnetic layer 32 fixes the magnetization of a first fixed magnetization layer 34 of the fixed magnetization layered body 33 in a predetermined orientation through the exchange interaction with the first fixed magnetization layer 34.

The fixed magnetization layered body 33 is formed by stacking the first fixed magnetization layer 34, a non-magnetic coupling layer 35, and a second fixed magnetization layer 36 in order from the antiferromagnetic layer 32 side. The fixed magnetization layered body 33 has a so-called synthetic ferrimagnetic structure where the magnetization of the first fixed magnetization layer 34 and the magnetization of the second fixed magnetization layer 36 are antiferromagnetically coupled by exchange coupling so that the orientations of their magnetizations are antiparallel to each other. That is, the magnetization of the first fixed magnetization layer 34 is fixed in a predetermined orientation by the antiferromagnetic layer 32, and the second fixed magnetization layer 36 has its magnetization fixed in the orientation opposite to that of the magnetization of the first fixed magnetization layer 34 through antiferromagnetic exchange coupling with the first fixed magnetization layer 34. The fixed magnetization layered body 33 may be a single fixed magnetization layer formed only of the first fixed magnetization layer 34. (The same applies to below-described example magnetoresistive elements according to this embodiment.)

Each of the first and second fixed magnetization layers 34 and 36 is formed of a ferromagnetic material of 1-30 nm in film thickness containing at least one of Co, Ni, and Fe. Ferromagnetic materials suitable for the first and second fixed magnetization layers 34 and 36 include CoFe, CoFeB, CoFeAl, NiFe, FeCoCu, and CoNiFe. Each of the first and second fixed magnetization layers 34 and 36 may be not only a single layer but also a layered body of two or more layers different in composition from one another.

Further, CoFe and NiFe are ferromagnetic materials suitable for the first fixed magnetization layer 34 because of their low resistivity. Since the magnetization of the first fixed magnetization layer 34 is oriented in the direction reverse to that of the magnetization of the second fixed magnetization layer 36, the first fixed magnetization layer 34 may act so as to reduce magnetoresistance change ARA. In this case, it is possible to control the reduction in the magnetoresistance change ARA by employing a ferromagnetic material of low resistivity.

The film thickness of the non-magnetic coupling layer 35 is determined so as to fall within such a range as to allow the first fixed magnetization layer 34 and the second fixed magnetization layer 36 to be antiferromagnetically exchange-coupled. The range is 0.2 nm to 1.5 nm (preferably, 0.2 nm to 0.9 nm). The non-magnetic coupling layer 35 is formed of a non-magnetic material such as Ru, Rh, Ir, a Ru-based alloy, a Rh-based alloy, or an Ir-based alloy. A non-magnetic material containing Ru and one of Co, Cr, Fe, Ni, and Mn or an alloy thereof is suitable as the Ru-based alloy.

Further, a ferromagnetic joining layer formed of a ferromagnetic material higher in saturation flux density than the first fixed magnetization layer 34, although its graphical illustration is omitted, may be provided between the first fixed magnetization layer 34 and the antiferromagnetic layer 32. This makes it possible to increase the exchange interaction between the first fixed magnetization layer 34 and the antiferromagnetic layer 32. As a result, it is possible to avoid a problem in which the orientation of the magnetization of the first fixed magnetization layer 34 is displaced or reversed from a predetermined orientation. The film thickness of the ferromagnetic joining layer may be extremely smaller than that of the first fixed magnetization layer 34, for example, 0.5 to 2.0 nm, in order to control reduction in the magnetoresistance change ARA.

The non-magnetic metal layer 37 is formed of, for example, a non-magnetic conductive material of 1.5 nm to 10 nm in film thickness. The material of the non-magnetic metal layer 37 is not limited in particular as long as the material is a non-magnetic material that causes spin-dependent interface scattering. Materials suitable for the non-magnetic metal layer 37 include one pure metal selected from Cu, Al, Au, Ag, and Cr, and a metal (alloy) containing the same.

The free magnetic layer 38 is formed of, for example, a soft magnetic material of 2 nm to 12 nm in film thickness containing at least one of Co, Ni, and Fe. Ferromagnetic materials suitable for the free magnetization layer 38 include CoFe, CoFeB, CoFeAl, NiFe, FeCoCu, and CoNiFe. The free magnetization layer 38 may be not only a single layer but also a layered body of two or more layers different in composition from one another.

Next, a description is given of the first magnetic coupling interruption layer 25 and the second magnetic coupling interruption layer 26 formed on the magnetoresistive film 30.

The first magnetic coupling interruption layer 25 is formed in contact with the free magnetization layer 38. The material of the first magnetic coupling interruption layer 25 is not limited in particular as long as the material is a non-magnetic material that causes spin-dependent interface scattering. The first magnetic coupling interruption layer 25 is determined to be, for example, 0.2 nm to 2 nm in film thickness. Materials suitable for the first magnetic coupling interruption layer 25 include one pure metal selected from Cu, Al, Au, Ag, and Cr, and a metal (alloy) containing the same.

The first magnetic coupling interruption layer 25, together with the second magnetic coupling interruption layer 26, weakens or cuts off the magnetic interaction between the free magnetization layer 38 and the upper terminal 22 by providing a distance therebetween. At the same timer the first magnetic coupling interruption layer 25 increases magnetoresistance change by causing spin-dependent interface scattering at the interface with the free magnetization layer 38.

The second magnetic coupling interruption layer 26 is formed of a non-magnetic material that contains at least one selected from the group consisting of Al, Ti, Cr, Mn, Zn, Nb, Mo, Ru, Rh, Pd, Ag, In, Hf, Ta, W, Ir, Pt, and Au and is different from the non-magnetic material of the first magnetic coupling interruption layer 25. By employing the above-described material for the second magnetic coupling interruption layer 26, the magnetic coupling of the free magnetization layer 38 and the upper terminal 22 is interrupted with a film thickness smaller than that of the conventionally employed Cu film. That is, comparing the case of forming the first and second magnetic coupling interruption layers 25 and 26 and the case of simply forming a Cu film, the exchange coupling magnetic field between the free magnetization layer 38 and the upper terminal 22 is smaller in the former case than in the latter case if the total film thickness of the first and second magnetic coupling interruption layers 25 and 26 and the film thickness of the Cu film are equal.

When an electron having information in a spin direction passes through the second magnetic coupling interruption layer 26, the second magnetic coupling interruption layer 26 acts to cause the electron to lose its information in the spin direction (so-called “spin information disappearance effect”). Since the electron loses spin information in the second magnetic coupling interruption layer 26, the magnetic interaction between the free magnetization layer 3B and the upper terminal 22 is suppressed.

Further, the film thickness of the second magnetic coupling interruption layer 26 is not limited, but may be determined to be 0.2 nm to 2 nm, for example.

Of the above-described materials for the second magnetic coupling interruption layer 26, those greater in resistivity than the Cu film (having a resistivity of 1.7 μΩcm) are preferred. The materials having greater resistivity than the Cu film are smaller in spin diffusion length than the Cu film. Accordingly, those materials can suppress conduction of electrons having spin information between the free magnetization layer 38 and the upper terminal 22. As a result, the magnetic coupling between the free magnetization layer 38 and the upper terminal 22 can be weakened, and moreover, interrupted.

Further, preferably, the second magnetic coupling interruption layer 26 is formed of a material having a resistivity of 10 μΩcm or more. This makes it possible to further weaken the magnetic coupling between the free magnetization layer 38 and the upper terminal 22. As a result, the second magnetic coupling interruption layer 26 can be reduced in thickness. The second magnetic coupling interruption layer 26 may be a layered body of stacked layers formed of different materials selected from those described above.

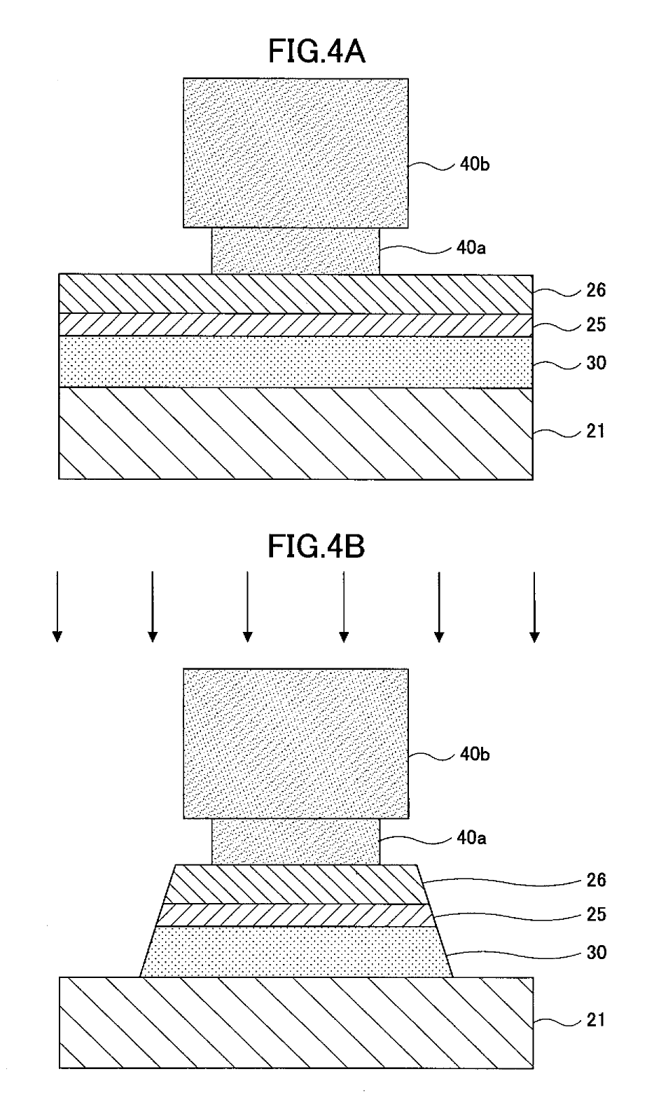

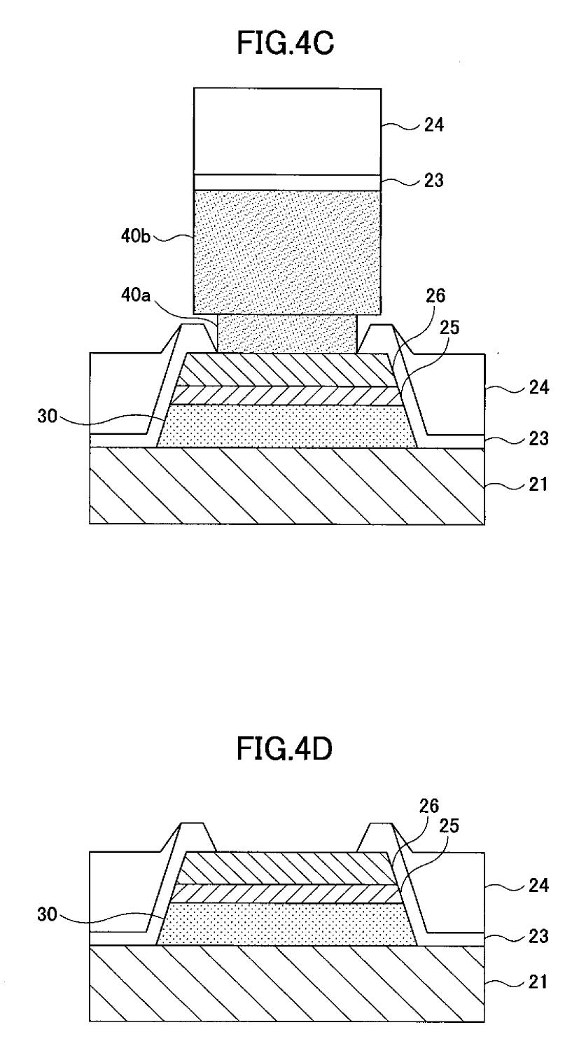

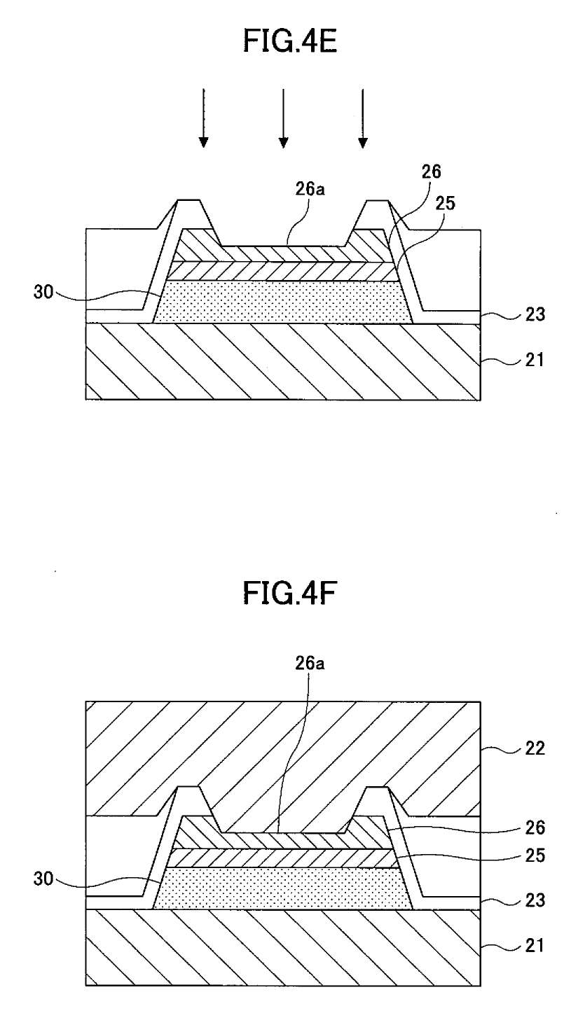

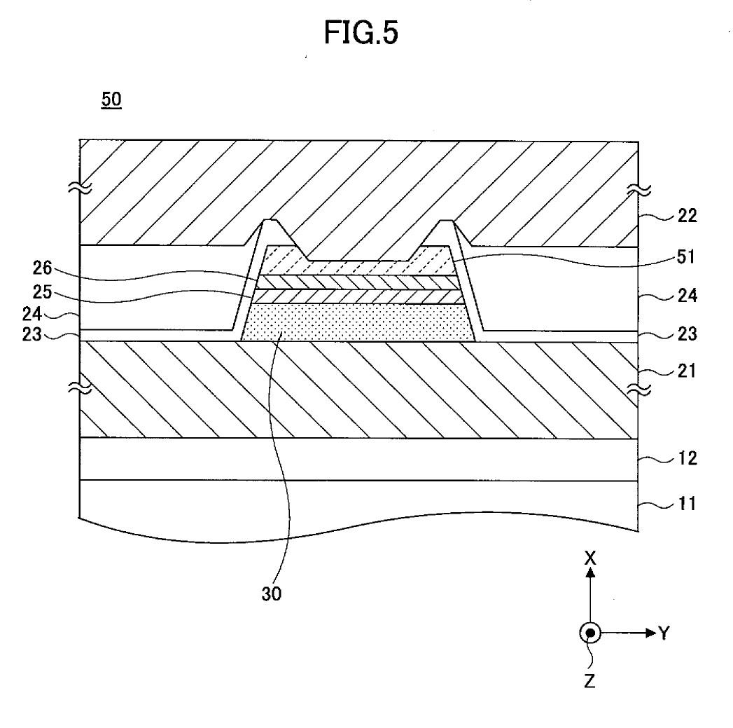

Next, a description is given, with reference to FIGS. 4A through 4F, of a method of forming a magnetoresistive element according to the first embodiment. FIGS. 4A through 4F show views from the medium opposing surface side the same as FIG. 2.

First, in the process of FIG. 4A, the lower terminal 21 is formed by plating or vacuum evaporation on the surface of an alumina film (not graphically illustrated) deposited on a ceramic substrate (wafer) (not graphically illustrated). Further, the magnetoresistive film 30 having the configuration of FIG. 3, the first magnetic coupling interruption layer 25, and the second magnetic coupling interruption layer 26 are successively formed on the lower terminal 21. Specifically, the magnetoresistive film 30, the first magnetic coupling interruption layer 25, and the second magnetic coupling interruption layer 26 are formed by, for example, DC magnetron sputtering.

Further, in the process of FIG. 4, heat treatment (magnetization fixing heat treatment) is performed while applying an external magnetic field, in order to fix the magnetization directions of the fixed magnetization layered body 33. The external magnetic field is applied, for example, in a Z-axial direction shown in FIG. 2 in the heat treatment that determines the magnetization direction of the fixed magnetization layered body 33. The magnetization fixing heat treatment oxidizes the surface of the second magnetic coupling interruption layer 26, so that an oxidized part is formed. However, the first magnetic coupling interruption layer 25 is not oxidized because the first magnetic coupling interruption layer 25 is covered with the second magnetic coupling interruption layer 26. The oxidized part is about 1 nm to 3 nm in thickness depending on the conditions of the magnetization fixing heat treatment and the type of the second magnetic coupling interruption layer 26.

Further, in the process of FIG. 4A, a resist film 40a and a resist film 40b each having a predetermined shape are formed on the second magnetic coupling interruption layer 26. Specifically, the resist films 40a and 40b are formed by photolithography where the magnetoresistive film 30 is to finally remain. Since the resist film 40a is narrower in width than the resist film 40b, the residue of the resist films 40a and 40b is less likely to remain at the time of lift-off. The shapes of the resist films 40a and 40b are not limited to those graphically illustrated. For example, the resist films 40a and 40b may be integrated into a single film having an inversed truncated pyramid shape. This produces the same effect as the resist films 40a and 40b, and can reduce the number of steps of the resist film formation process.

Next, in the process of FIG. 4B, the second magnetic coupling interruption layer 26, the first magnetic coupling interruption layer 25, and the magnetoresistive film 30 are etched by, for example, ion milling using the resist film 40b as a mask, so that the lower terminal 21 is exposed. The width of the magnetoresistive film 30 formed by this is controlled by the width of the resist film 40b. Further, the width of the magnetoresistive film 30 is greater on the lower layer side than on the upper layer side.

Next, in the process of FIG. 4C, the insulating film 23 and the magnetic domain control film 24 are formed on the surface of the structure of FIG. 4B. The insulating film 23 is formed so as to cover the surface of the lower terminal 21 and the sidewalls of the magnetoresistive film 30, the first magnetic coupling interruption layer 25, and the second magnetic coupling interruption layer 26. The insulating film 23 is formed so as to further cover the surface of the second magnetic coupling interruption layer 26 except for an area in which the resist film 40a is formed. Further, the magnetic domain control film 24 is deposited on the surface of the insulating film 23.

Next, in the process of FIG. 4D, the resist films 40a and 40b are dissolved using an organic solvent or the like, so that the insulating film 23 and the magnetic domain control film 24 on the resist film 40b are removed together with the resist films 40a and 40b. Further, the residue of the resist films 40a and 40b may be removed by oxygen ashing if necessary.

Next, in the process of FIG. 4E, part of the second magnetic coupling interruption layer 26 is removed by etching, so that a metal surface 26a of the second magnetic coupling interruption layer 26 is exposed. This removes the oxidized part having high resistance formed on the surface of the second magnetic coupling interruption layer 26 by the magnetization fixing heat treatment of the process of FIG. 4A, so that the connection resistance between the second magnetic coupling interruption layer 26 and the upper terminal 22 to be formed next is reduced. In this etching, the etching rate is predetermined, and the amount of etching is controlled by etching time. Further, the etching method may be either dry etching or wet etching. However, it is preferable to employ dry etching in that the amount of etching of the second magnetic coupling interruption layer 26 can be determined with good accuracy.

Next, in the process of FIG. 4F, the upper terminal 22 to cover the structure of FIG. 4E is formed by plating or the like. As a result, the upper terminal 22 is in contact with the metal surface 26a of the second magnetic coupling interruption layer 26. Thereby, the magnetoresistive element 20 shown in FIG. 2 is formed. Next, the induction-type recording element 13 having the configuration of FIG. 2 is formed on the surface of the magnetoresistive element 20 by a known method.

According to this embodiment, the first magnetic coupling interruption layer 25 is formed in contact with the free magnetization layer 38 and is formed of a non-magnetic material that causes spin-dependent interface scattering. This increases magnetoresistance change. Further, the second magnetic coupling interruption layer 26 is formed of the above-described material, and with a film thickness smaller than that of the conventionally employed Cu film, interrupts the magnetic coupling of the free magnetization layer 38 and the upper terminal 22. Accordingly, the sum of the film thicknesses of the first magnetic coupling interruption layer 25 and the second magnetic coupling interruption layer 26 can be smaller than the film thickness of the conventional magnetic coupling interruption layer formed of a Cu film alone without increasing the exchange coupling magnetic field of the free magnetization layer 38 and the upper terminal 22. As a result, the read gap length can be reduced. Accordingly, because of the synergy of the increase in magnetoresistance change and the reduction in the read gap length, it is possible to realize a magnetoresistive element capable of achieving high recording density.

### Second Example Magnetoresistive Element

FIG. 5 is a diagram showing part of the medium opposing surface of a second example magnetoresistive element 50 according to the first embodiment. The induction-type recording element 13 shown in FIG. 2 may be or may not be provided on the magnetoresistive element 50. The same applies to below-described example magnetoresistive elements according to this embodiment. In FIG. 5, the elements corresponding to those described above are referred to by the same numerals, and a description thereof is omitted.

The magnetoresistive element 50, which is a variation of the magnetoresistive element 20 (FIG. 2), has a third magnetic coupling interruption layer 51 provided between the second magnetic coupling interruption layer 26 and the upper terminal 22.

Referring to FIG. 5, the magnetoresistive element 50 has the lower terminal 21, the magnetoresistive film 30, the first magnetic coupling interruption layer 25, the second magnetic coupling interruption layer 26, the third magnetic coupling interruption layer 51, and the upper terminal 22 stacked on the alumina film 12 formed on the surface of the ceramic substrate 11. The magnetoresistive film 30 has the configuration shown in FIG. 3, and the first magnetic coupling interruption layer 25 is in contact with the free magnetization layer 38 of the magnetoresistive film 30. The magnetoresistive film 30 is electrically connected to the lower terminal 21 and to the upper terminal 22 (through the first, second, and third magnetic coupling interruption layers 25, 26, and 51). The magnetoresistive element 50 has the same configuration as the magnetoresistive element 20 except for having the third magnetic coupling interruption layer 51 provided between the second magnetic coupling interruption layer 26 and the upper terminal 22.

The material of the third magnetic coupling interruption layer 51 is selected from one pure metal selected from Cu, Al, Au, Ag, and Cr, and a metal (alloy) containing the same. Preferably, the third magnetic coupling interruption layer 51 is formed of the same material as the first magnetic coupling interruption layer 25. By thus forming a layered body having the second magnetic coupling interruption layer 26 interposed between the first magnetic coupling interruption layer 25 and the third magnetic coupling interruption layer 51, the thickness of the entire layered body of the first through third magnetic coupling interruption layers 25, 26, and 51 can be reduced compared with the case of not providing the second magnetic coupling interruption layer 26.

Further, it is preferable that the first magnetic coupling interruption layer 25 be formed of a Cu film in terms of increasing magnetoresistance change. It is further preferable that the third magnetic coupling interruption layer 51 also be formed of a Cu film. In this case, it is further preferable that the second magnetic coupling interruption layer 26 be formed of a Ta film or a Ru film in terms of further reducing the thickness of the entire layered body.

The magnetoresistive element 50 produces the same effects as the magnetoresistive element 20. Further, by having the second magnetic coupling interruption layer 26 provided between the first magnetic coupling interruption layer 25 and the third magnetic coupling interruption layer 51 formed of the same material as the first magnetic coupling interruption layer 25, the magnetoresistive element 50 can be reduced in the thickness of the entire layered body of the first through third magnetic coupling interruption layers 25, 26, and 51 compared with the case of not providing the second magnetic coupling interruption layer 26.

The method of manufacturing the magnetoresistive element 50 is substantially the same as the method of manufacturing the magnetoresistive element 20 shown in FIGS. 4A through 4F except for forming the third magnetic coupling interruption layer 51 on the second magnetic coupling interruption layer 26, and accordingly, a description thereof is omitted.

### Third Example Magnetoresistive Element

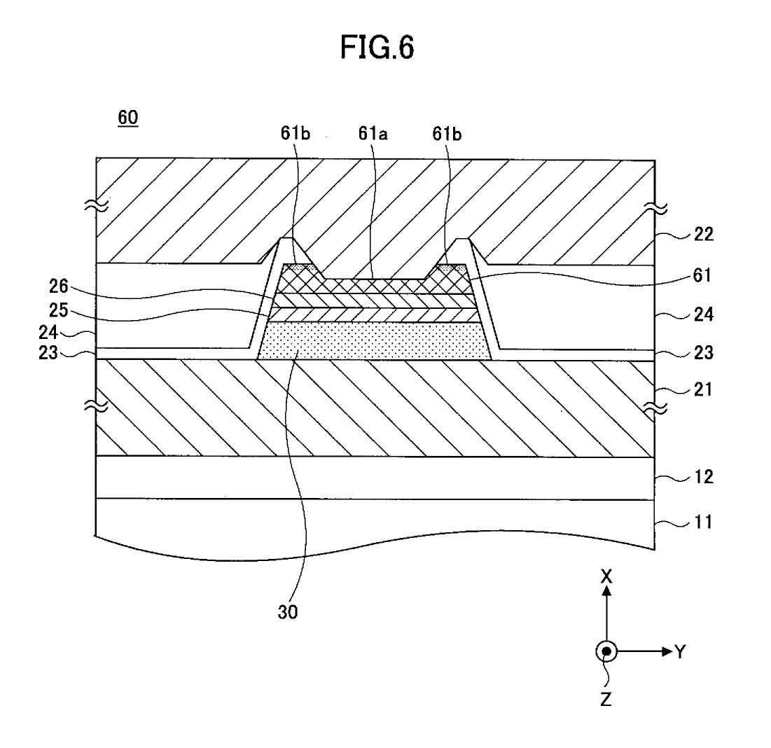

FIG. 6 is a diagram showing part of the medium opposing surface of a third example magnetoresistive element 60 according to the first embodiment. In FIG. 6, the elements corresponding to those described above are referred to by the same numerals, and a description thereof is omitted.

The magnetoresistive element 60, which is a variation of the magnetoresistive element 20 (FIG. 2), has a soft magnetic protection film 61 provided between the second magnetic coupling interruption layer 26 and the upper terminal 22.

Referring to FIG. 6, the magnetoresistive element 60 has the lower terminal 21, the magnetoresistive film 30, the first magnetic coupling interruption layer 25, the second magnetic coupling interruption layer 26, the soft magnetic protection film 61, and the upper terminal 22 stacked on the alumina film 12 formed on the surface of the ceramic substrate 11. The magnetoresistive film 30 has the configuration shown in FIG. 3, and the first magnetic coupling interruption layer 25 is in contact with the free magnetization layer 38 of the magnetoresistive film 30. The magnetoresistive film 30 is electrically connected to the lower terminal 21 and to the upper terminal 22 (through the first and second magnetic coupling interruption layers 25 and 26 and the soft magnetic protection film 61). The magnetoresistive element 60 has the same configuration as the magnetoresistive element 20 except for having the soft magnetic protection film 61 provided between the second magnetic coupling interruption layer 26 and the upper terminal 22.

The material of the soft magnetic protection film 61 is not limited in particular as long as the material is a metal or alloy soft magnetic material. The thickness of the soft magnetic protection film 61 is determined to be, for example, 1 nm to 10 nm. The soft magnetic protection film 61 is formed of a soft magnetic material containing at least one selected from the group consisting of, for example, Co, Ni, and Fe. Specific examples of the soft magnetic material include Ni₈₀Fe₂₀, CoZrNb, FeN, FeSiN, FeCo, and CoNiFe. The soft magnetic protection film 61 is preferably formed of a material having the same composition of the upper terminal 22 formed thereon in terms of enabling its crystal growth with good lattice matching. The soft magnetic protection film 61 prevents oxidation of the first and second magnetic coupling interruption layers 25 and 26 in heat treatment described below.

Further, the soft magnetic protection film 61 has a metal surface 61a thereof in contact with the upper terminal 22 on the soft magnetic protection film 61. An oxidized part 61b is formed on the surface of the soft magnetic protection film 61 on each side of the contact part in the Y-axial directions (core width directions). On the other hand, the soft magnetic protection film 61 has the resistivity of the material itself at the metal surface 61a. Therefore, it is possible to keep the resistance (electric resistance) between the upper terminal 22 and the soft magnetic protection film 61 at a low level. Accordingly, it is possible to keep the element resistance of the magnetoresistive element 60 at a low level.

The element resistance of the magnetoresistive element 60 is the sum of the resistance generated from the free magnetization layer 38 and the fixed magnetization layered body 33 (magnetic resistance), which depends on magnetoresistance, that is, the relative directional relationship between the magnetization of the free magnetization layer 38 and the magnetization of the second fixed magnetization layer 36 of the fixed magnetization layered body 33 shown in FIG. 3; the resistance between the magnetoresistive film 30 and each of the lower terminal 21 and the upper terminal 22 (connection resistance); the resistance of the films other than the magnetoresistive film 30 formed of the free magnetization layer 38 and the fixed magnetization layered body 33 (parasitic resistance); and the resistance of the lower terminal 21 and the upper terminal 22 themselves (terminal resistance). That is, element resistance=magnetic resistance+connection resistance+parasitic resistance+terminal resistance. Further, the magnetoresistance ratio is expressed as magnetoresistance change÷element resistance×100(%). The magnetoresistance change is expressed as a difference obtained by subtracting the magnetic resistance in where the magnetization of the free magnetization layer 38 and the magnetization of the second fixed magnetization layer 36 are parallel from the magnetic resistance in where the magnetization of the free magnetization layer 38 and the magnetization of the second fixed magnetization layer 36 are antiparallel.

According to the magnetoresistive element 60, the first magnetic coupling interruption layer 25, the second magnetic coupling interruption layer 26, and the soft magnetic protection film 61 are stacked in this order from the free magnetization layer 38 side between the free magnetization layer 38 and the upper terminal 22. Since the upper terminal 22 is in contact with the metal surface 61a of the soft magnetic protection film 61, it is possible to keep the connection resistance between the upper terminal 22 and the soft magnetic protection film 61 at a low level. Accordingly, it is possible to keep the element resistance of the magnetoresistive element 60 at a low level. Further, since the soft magnetic protection film 61 is formed of a soft magnetic material, the read gap length is the distance from the surface of the lower terminal 21 to the lower surface of the soft magnetic protection film 61, that is, the distance from the surface of the lower terminal 21 to the surface of the second magnetic coupling interruption layer 26. Since the soft magnetic protection film 61 protects the second magnetic coupling interruption layer 26 against etching, the film thicknesses of the first and second magnetic coupling interruption layers 25 and 26 are maintained as they are at the time of deposition. Accordingly, the film thicknesses of the first and second magnetic coupling interruption layers 25 and 26 may be controlled only at the time of deposition, and are not affected by the amount of subsequent etching or variations therein. As a result, the film thicknesses of the first and second magnetic coupling interruption layers 25 and 26 can be excellently controlled, thus resulting in good controllability of the read gap length. As a result, it is possible to realize a magnetoresistive element with a small read gap length, so that it is possible to realize a magnetoresistive element capable of achieving high recording density.

Next, a description is given of a method of manufacturing the magnetoresistive element 60.

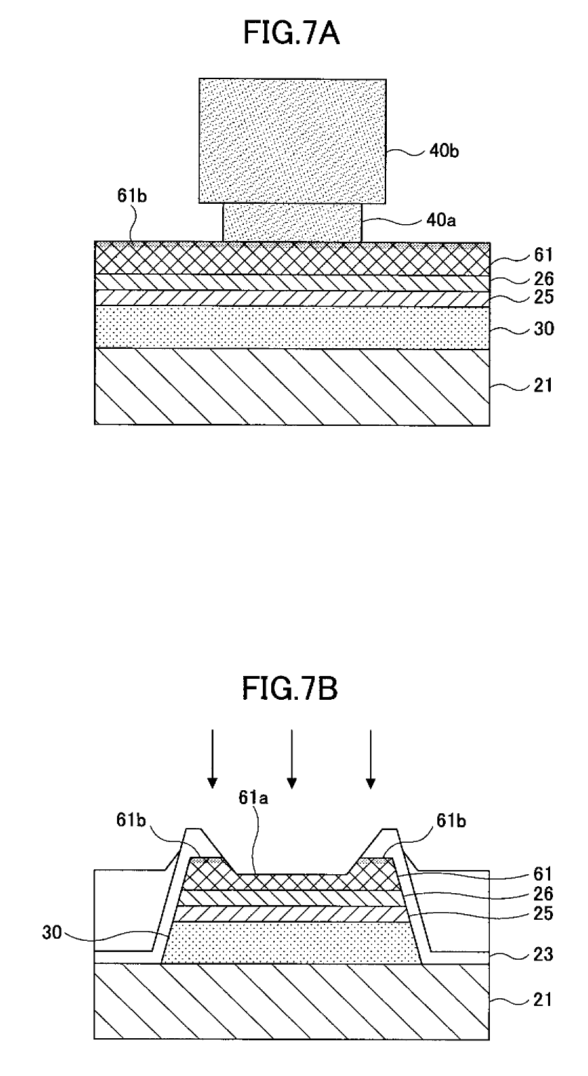

The method of manufacturing the magnetoresistive element 60 is substantially the same as the method of manufacturing the magnetoresistive element 20 shown in FIGS. 4A through 4F except for having the process of forming the soft magnetic protection film 61 on the second magnetic coupling interruption layer 26 and the process of exposing the metal surface 61a by removing (part of) the oxidized part 61b of the soft magnetic protection film 61. A description is given below, with reference to FIGS. 7A and 7B, of the different processes.

In the process of FIG. 7A, the lower terminal 21 is formed by plating or vacuum evaporation on the surface of an alumina film (not graphically illustrated) deposited on a ceramic substrate (wafer) (not graphically illustrated). Further, the magnetoresistive film 30 having the configuration of FIG. 3, the first magnetic coupling interruption layer 25, and the second magnetic coupling interruption layer 26 are successively formed on the lower terminal 21. Specifically, the magnetoresistive film 30, the first magnetic coupling interruption layer 25, and the second magnetic coupling interruption layer 26 are formed by, for example, DC magnetron sputtering.

Further, in the process of FIG. 7A, the soft magnetic protection film 61 of the above-described material is formed on the second magnetic coupling interruption layer 26. The soft magnetic protection film 61 may be formed by any of sputtering, CVD, and vacuum evaporation.

Further, in the process of FIG. 7A, heat treatment (magnetization fixing heat treatment) is performed while applying an external magnetic field, in order to fix the magnetization directions of the fixed magnetization layered body 33. The conditions of this heat treatment are the same as those of FIG. 4A.

Before and after the magnetization fixing heat treatment is performed after forming the soft magnetic protection film 61 and at the time of forming a resist film in the next process, the ceramic substrate (on which the magnetoresistive film 30 through the soft magnetic protection film 61 are formed) is taken out of a film formation chamber and conveyed to a heat treatment apparatus or an etching apparatus. At this point, the soft magnetic protection film 61 is exposed to air. Therefore, the oxidized part 61b such as a natural oxide film is formed on the surface of the soft magnetic protection film 61. The oxidized part 61b is about 1 nm to 3 nm in thickness depending on the type of the soft magnetic protection film 61.

Next, in the process of FIG. 7B, the same processes as those of FIGS. 4B through 4D are performed. At this point, an oxidized part (not graphically illustrated) may be formed on each side surface of each of the magnetoresistive film 30, the first magnetic coupling interruption layer 25, the second magnetic interruption layer 26, and the soft magnetic protection film 61 the same as on the surface of the soft magnetic protection film 61.

Further, in the process of FIG. 7B, the oxidized part 61b is partially removed by removing part of the soft magnetic protection film 61 by etching, so that the metal surface 61a of the soft magnetic protection film 61 is exposed. This removes part of the oxidized part 61b having high resistance formed on the surface of the soft magnetic protection film 61 by the magnetization fixing heat treatment of the process of FIG. 7A, so that the connection resistance between the soft magnetic protection film 61 and the upper terminal 22 to be formed next is reduced. In this etching, the etching rate is predetermined, and the amount of etching is controlled by etching time. Further, the etching method may be either dry etching or wet etching. However, it is preferable to employ dry etching in that the amount of etching of the soft magnetic protection film 61 can be determined with good accuracy.

The process subsequent to the process of FIG. 7B is substantially the same as the process of FIG. 4F. Thereby, the magnetoresistive element 60 shown in FIG. 6 is formed.

According to this manufacturing method, the connection resistance between the upper terminal 22 and the soft magnetic protection film 61 can be kept low by exposing the metal surface 61a by removing part of the oxidized part 61b formed on the surface of the soft magnetic protection film 61. At the same time, the read gap length of the magnetoresistive element 60 is the distance from the surface of the lower terminal 21 to the surface of the second magnetic coupling interruption layer 26. Since no oxidized part is formed in the second magnetic coupling interruption layer 26 by the magnetization fixing heat treatment, and no etching is performed on the second magnetic coupling interruption layer 26, the read gap length is determined by the film thickness at the time of deposition. Accordingly, it is possible to form a magnetoresistive element having good controllability of the read gap length. The oxidized part 61b exists on the surface of the soft magnetic protection film 61 on each side of the contact part (metal surface 61a) of the soft magnetic protection film 61 and the upper terminal 22 in the core width directions because the corresponding part of the soft magnetic protection film 61 is not ground by the above-described etching process.

Alternatively, the entire surface of the soft magnetic protection film 61 may be removed by the above-described etching process. In this case, the metal surface 61a extends to each side end of the soft magnetic protection film 61 in the core width directions. Therefore, the oxidized part 61b of the surface of the soft magnetic protection film 61 does not remain.

### Fourth Example Magnetoresistive Element

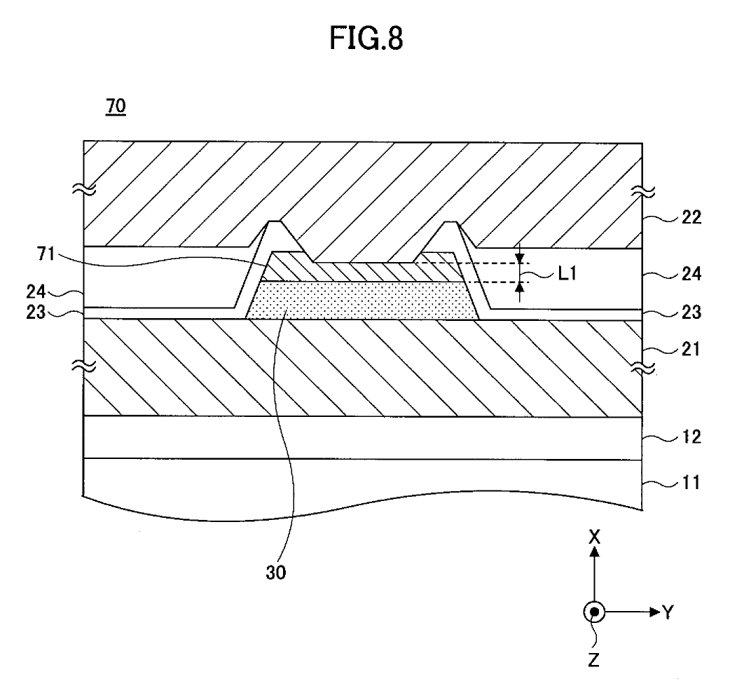

FIG. 8 is a diagram showing part of the medium opposing surface of a fourth example magnetoresistive element 70 according to the first embodiment. In FIG. 8, the elements corresponding to those described above are referred to by the same numerals, and a description thereof is omitted.

Referring to FIG. 8, the magnetoresistive element 70 has the lower terminal 21, the magnetoresistive film 30, a Ta film 71, and the upper terminal 22 stacked on the alumina film 12 formed on the surface of the ceramic substrate 11. The magnetoresistive film 70 has the configuration shown in FIG. 3, and the Ta film 71 is in contact with the free magnetization layer 38 of the magnetoresistive film 30. The magnetoresistive film 30 is electrically connected to the lower terminal 21 and to the upper terminal 22 (through the Ta film 71). The magnetoresistive element 70 has the same configuration as the magnetoresistive element 20 except for having the Ta film 71 provided between the magnetoresistive film 30 and the upper terminal 22.

The Ta film 71 suppresses the exchange coupling magnetic field of the free magnetization layer 38 and the upper terminal 22 more than the conventionally employed Cu film. That is, the Ta film 71 formed with a thickness L1 (the distance between the surface of the magnetoresistive film 30 and the lower surface of the upper terminal 22) shown in FIG. 8 can suppress the exchange coupling magnetic field of the free magnetization layer 38 and the upper terminal 22 more than a Cu film formed with the same thickness. Therefore, the Ta film 71 can be thinner than the Cu film without increasing the exchange coupling magnetic field.

In the case where the exchange coupling magnetic field of the free magnetization layer 38 and the upper terminal 22 is less than or equal to 10 Oe, the film thickness (L1) of the Ta film 71 can be reduced to 0.9 nm according to Example 2 described below. This shows that the Ta film 71 can be thinner than the Cu film (Comparative Example 1 described below) by 1.5 nm or more. Accordingly, the film thickness (L1) of the Ta film 71 is determined to be 0.9 nm or more. Further, the film thickness (L1) of the Ta film 71 is preferably 5 nm or less in terms of preventing the read gap length from being excessively elongated to adversely affect reproduction output at high recording density. Further, the film thickness (L1) of the Ta film 71 is more preferably 0.9 nm to 5 nm in terms of both suppression of the exchange coupling magnetic field and realization of good reproduction output and SN ratio at high recording density. Further, it is extremely preferable that the film thickness (L1) of the Ta film 71 be 0.9 nm to 2.3 nm in terms of extremely excellent suppression of the exchange coupling magnetic field as described below in Example 2.

According to the magnetoresistive element 70, it is possible to suppress the exchange coupling magnetic field of the free magnetization layer 38 and the upper terminal 22 and to further reduce the read gap length by providing the Ta film 71 of the above-described predetermined film thickness between the magnetoresistive film 30 and the upper terminal 22.

The method of manufacturing the magnetoresistive element 70 is substantially the same as the method of manufacturing the magnetoresistive element 20 shown in FIGS. 4A through 4F except for forming the Ta film 71 on the magnetoresistive film 30, and accordingly, a description thereof is omitted.

The magnetoresistive element 70 has the magnetoresistive film 30 shown in FIG. 3. Alternatively, in place of the magnetoresistive film 30, a ferromagnetic tunneling magnetoresistance (TMR) film having a non-magnetic insulating film of a non-magnetic insulating material in place of the non-magnetic metal layer 37 may be used. The TMR film produces ferromagnetic tunneling magnetoresistance, and detects a signal magnetic field from a magnetic recording medium in the same manner as the magnetoresistive film 30. The non-magnetic insulating layer is, for example, 0.2 nm to 2.0 nm in thickness, and is formed of an oxide of one selected from the group consisting of Mg, Al, Ti, and Zr. Examples of such an oxide include MgO, AlOₓ, TiOₓ, and ZrOₓ. Here, x indicates that the composition may deviate from the composition of the compound of the materials. Further, the non-magnetic insulating layer may also be formed of a nitride or oxynitride of one selected from the group consisting of Al, Ti, and Zr. Examples of such a nitride include AlN, TiN, and ZrN. Such a non-magnetic insulating layer may also be applied to the magnetoresistive element of the following example.

### Fifth Example Magnetoresistive Element

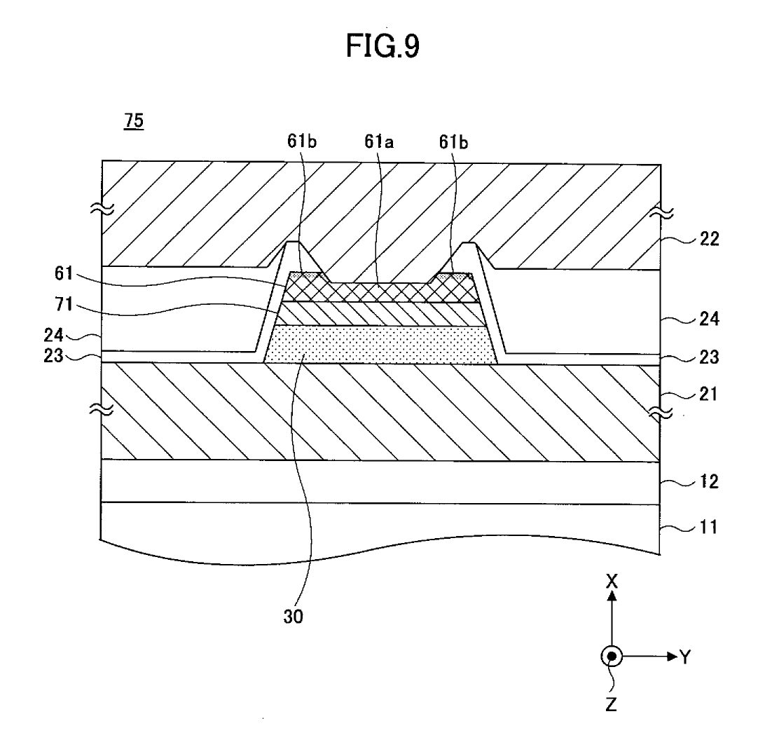

FIG. 9 is a diagram showing part of the medium opposing surface of a fifth example magnetoresistive element 75 according to the first embodiment. In FIG. 9, the elements corresponding to those described above are referred to by the same numerals, and a description thereof is omitted.

The magnetoresistive element 75, which is a variation of the magnetoresistive elements 60 (FIG. 6) and 70 (FIG. 8), has the soft magnetic protection film 61 provided between the Ta film 71 and the upper terminal 22.

Referring to FIG. 9, the magnetoresistive element 75 has the lower terminal 21, the magnetoresistive film 30, the Ta film 71, the soft magnetic protection film 61, and the upper terminal 22 stacked on the alumina film 12 formed on the surface of the ceramic substrate 11. The magnetoresistive film 30 has the configuration shown in FIG. 3. The Ta film 71 is formed on the free magnetization layer 38 of the magnetoresistive film 30. The soft magnetic protection film 61 is formed on the Ta film 71, and the upper terminal 22 is in contact with the metal surface 61a of the soft magnetic protection film 61.

The material and film thickness of the soft magnetic protection film 61 of the magnetoresistive element 75 are selected from the same materials and film thicknesses as the soft magnetic protection film 61 of the magnetoresistive element 60.

Further, the soft magnetic protection film 61 of the magnetoresistive element 75 is manufactured by the same process and the same process order as the soft magnetic protection film 61 of the magnetoresistive element 60. That is, in the case of the magnetoresistive element 75, the Ta film 71 and the soft magnetic protection film 61 are successively formed and magnetization fixing heat treatment is performed in the process of FIG. 7A of the method of manufacturing the magnetoresistive element 60. Then, the process of FIG. 7B is performed the same. As a result, the Ta film 71 avoids oxidation due to the magnetization fixing heat treatment, and avoids a change in its film thickness due to etching. Accordingly, the film thickness of the Ta film 71 at the time of deposition is maintained as its final film thickness. Therefore, the film thickness of the Ta film 71 may be controlled only at the time of deposition, and is not affected by the amount of subsequent etching or variations therein. As a result, the film thickness of the Ta film 71 is excellently controlled, thus resulting in good controllability of the read gap length.

Further, the Ta film 71 can suppress the exchange coupling magnetic field of the free magnetization layer 38 and the upper terminal 22, and can achieve reduction in film thickness. As a result, it is possible to realize a magnetoresistive element with a small read gap length, so that it is possible to realize a magnetoresistive element capable of achieving high recording density.

According to the magnetoresistive element 75, since it is possible to keep the connection resistance between the upper terminal 22 and the soft magnetic protection film 61 at low level, it is possible to keep the element resistance of the magnetoresistive element 75 at low level. Further, since the soft magnetic protection film 61 is formed of a soft magnetic material, the read gap length is the distance from the surface of the lower terminal 21 to the lower surface of the soft magnetic protection film 61, that is, the distance from the surface of the lower terminal 21 to the surface of the Ta film 71. Since the soft magnetic protection film 61 protects the Ta film 71 against etching, the film thickness of the Ta film is maintained as it is at the time of deposition. Accordingly, the film thickness of the Ta film 71 may be controlled only at the time of deposition, and is not affected by the amount of subsequent etching or variations therein. Further, the Ta film 71 can suppress the exchange coupling magnetic field of the free magnetization layer 38 and the upper terminal 22, and can achieve reduction in film thickness. As a result, the film thickness of the Ta film is excellently controlled, thus resulting in good controllability of the read gap length. As a result, it is possible to realize a magnetoresistive element with a narrower read gap, so that it is possible to realize a magnetoresistive element capable of achieving high recording density.

To the magnetoresistive element 75, the second magnetic coupling interruption layer 26 (however, except Ta) of the magnetoresistive element 20 shown in FIG. 2 may be applied instead of the Ta film 71.

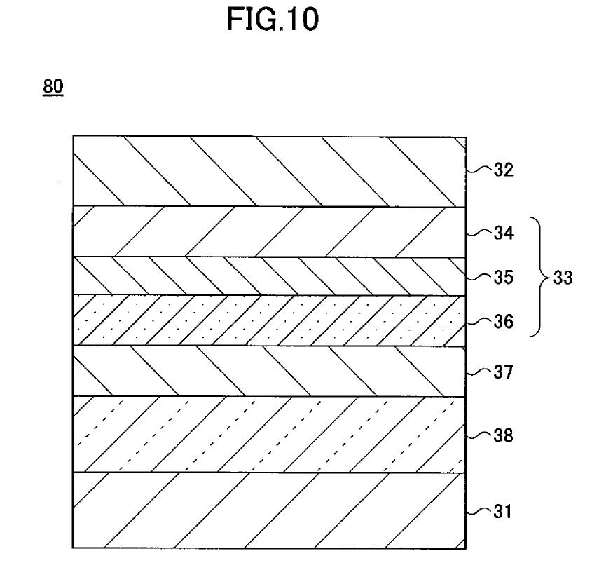

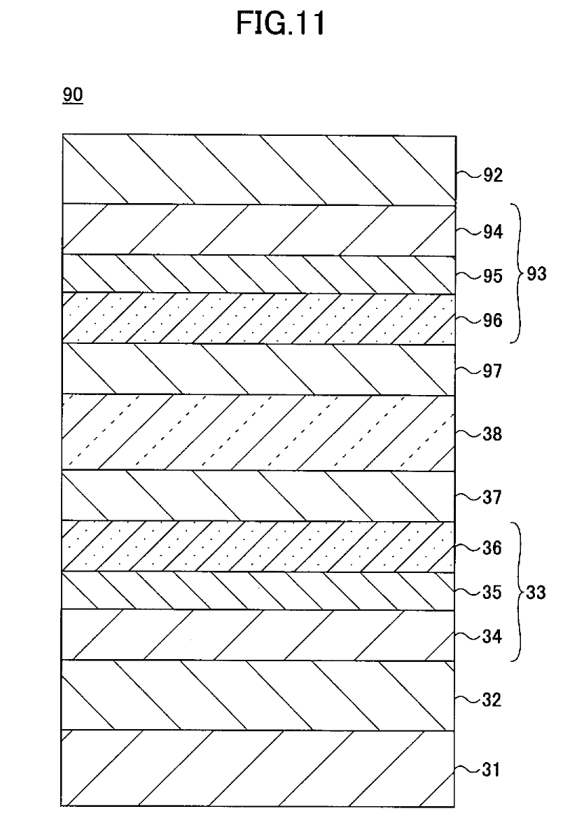

In the magnetoresistive elements 70 (FIG. 8) and 75, the magnetoresistive film 30 may be configured as shown in FIGS. 10 and 11.

FIG. 10 is a cross-sectional view of a magnetoresistive film 80, which is a first variation of the magnetoresistive film 30. FIG. 11 is a cross-sectional view of a magnetoresistive film 90, which is a second variation of the magnetoresistive film 30. In FIGS. 10 and 11, the elements corresponding to those described above are referred to by the same numerals, and a description thereof is omitted.

Referring to FIG. 10, the magnetoresistive film 80 includes the underlayer 31, the free magnetization layer 38, the non-magnetic metal layer 37, the fixed magnetization layered body 33 (the second fixed magnetization layer 36, the non-magnetic coupling layer 35, and the first fixed magnetization layer 34), and the antiferromagnetic layer 32, which are stacked successively from the lower terminal (not graphically illustrated) side. In the above-described magnetoresistive elements 70 and 75, the Ta film 71 is formed on the antiferromagnetic layer 32.

Referring to FIG. 11, the magnetoresistive film 90 includes the underlayer 31, the lower antiferromagnetic layer 32, the lower fixed magnetization layered body 33, the lower non-magnetic metal layer 37, the free magnetization layer 38, an upper non-magnetic metal layer 97, an upper fixed magnetization layered body 93, and an upper antiferromagnetic layer 92, which are stacked successively from the lower terminal side. That is, the magnetoresistive film 90 has a so-called dual spin-valve structure. The structure of the magnetoresistive film 90 from the free magnetization layer 38 down has the same configuration as the magnetoresistive film 30 shown in FIG. 3, and the corresponding layers are referred to by the same numerals. Further, the materials and film thicknesses of the upper non-magnetic metal layer 97, the upper fixed magnetization layered body 93, and the upper antiferromagnetic layer 92 are selected from the same materials and film thicknesses of the above-described lower non-magnetic metal layer 37, the lower fixed magnetization layered body 33, and the lower antiferromagnetic magnetic layer 32, respectively. However, the upper fixed magnetization layered body 93 is formed of an upper second fixed magnetization layer 96, an upper non-magnetic coupling layer 95, and an upper first fixed magnetization layer 94, which are successively stacked from the upper non-magnetic metal layer 97 side.

By thus configuring the magnetoresistive films 80 (first variation) and 90 (second variation), it is possible, with the Ta film 71 formed on the antiferromagnetic layer 32 or the upper antiferromagnetic layer 92, to suppress the magnetic coupling of the upper terminal 22 and the antiferromagnetic layer 32 or the upper antiferromagnetic layer 92 (or the first fixed magnetization layer 34 or the upper first fixed magnetization layer 94). As a result, it is possible to realize a magnetoresistive element in which the read gap length is further reduced.

Next, a description is given of examples according to the first embodiment.

### Example 1

In Example 1 (Examples 1-1 through 1-3) layered bodies having the following configurations were made and their respective exchange coupling magnetic fields were measured in order to measure the degree of interruption of the exchange coupling magnetic field of the free magnetization layer 38 and the upper terminal 22 by the first magnetic coupling interruption layer 25 and the second magnetic coupling interruption layer 26 forming the magnetoresistive element 20 according to the first embodiment shown in FIG. 3.

### Example 1-1

The configuration of the layered bodies of Example 1-1 is as follows. The parenthesized numeric values show film thickness, which is shown in the same manner in the following examples and comparative examples. Further, the layers are shown in order from the lower side. In the case where a layer is formed of multiple layers, a layer shown on the right side is formed on a layer shown on the left side.

Underlayer: Ta film (5 nm)/Ru film (5 nm)

Antiferromagnetic layer: IrMn (5 nm)

First magnetic layer: Ni₈₀Fe₂₀ (5 nm)

First magnetic coupling interruption layer: Cu film (varied from 0.25 nm to 2.0 nm)

Second magnetic coupling interruption layer: Ta film (0.5 nm)

Second magnetic layer: Ni₈₀Fe₂₀ (10 nm)

Protection film: Ru film (5 nm)

Each layered body of Example 1-1 was made as follows. First, a layered body having the above-described composition and film thickness from a Ta film (5 nm) serving as the underlayer to the protection film was formed on a silicon substrate having a thermal oxide film formed thereon in an ultra-high vacuum (a vacuum of 2×10⁻⁶ Pa or below) atmosphere by DC magnetron sputtering using a sputtering apparatus without heating the substrate.

Next, the obtained layered body was subjected to magnetization fixing heat treatment. The conditions of the magnetization fixing heat treatment were a heating temperature of 300° C., a treatment time of 3 hours, and an applied magnetic field of 1952 kA/m.

The exchange coupling magnetic field of the first magnetic layer and the second magnetic layer of the layered body thus obtained was measured. In the layered body of Example 1-1 having the above-described configuration, the orientation of the magnetization of the first magnetic layer is fixed by the action of the antiferromagnetic layer. Without application of a magnetic field, the magnetization of the second magnetic layer is oriented in a direction reverse to that of the magnetization of the first magnetic layer because of the exchange coupling magnetic field with the first magnetic layer. A magnetic field is applied in the same direction as and in a direction reverse to that of the magnetization of the first magnetic layer in a film plane and the hysteresis loop of the amount of magnetization was measured using a vibrating sample magnetometer (VSM). The hysteresis loop (vertical axis: the amount of magnetization, horizontal axis: magnetic field) is not bilaterally symmetric with respect to the magnetization amount axis (magnetic field=0), and is displaced along the magnetic field axis. This displacement is defined as the exchange coupling magnetic field. The exchange coupling magnetic field was also obtained in the same manner in the following examples and comparative examples.

### Example 1-2

The layered bodies of Example 1-2 were configured the same as those of Example 1-1 except that the film thickness of the Ta film of the second magnetic coupling interruption layer was 1.0 nm and that the film thickness of the Cu film of the first magnetic coupling interruption layer was varied from 1.0 nm to 2.0 nm. The layered bodies thus configured were made in substantially the same manner as those of Example 1-1, and their respective exchange coupling magnetic fields were obtained.

### Example 1-3

The layered bodies of Example 1-3 were configured the same as those of Example 1-1 except that the film thickness of the Cu film of the first magnetic coupling interruption layer was 1.0 nm and that the film thickness of the Ta film of the second magnetic coupling interruption layer was varied from 0.5 nm to 1.5 nm, and their respective exchange coupling magnetic fields were obtained.

### Example 2

In Example 2, layered bodies having the following configuration were made and their respective exchange coupling magnetic fields were measured in order to measure the degree of interruption of the exchange coupling magnetic field of the free magnetization layer 3B and the upper terminal 22 by the Ta film 71 forming the magnetoresistive element 70 according to the first embodiment shown in FIG. 8.

Underlayer: Ta film (5 nm)/Ru film (5 nm)

Antiferromagnetic layer: IrMn (5 nm)

First magnetic layer: Ni₈₀Fe₂₀ (5 nm)

Ta film 71: Ta film (varied from 0.5 nm to 2.0 nm)

Second magnetic layer: Ni₈₀Fe₂₀ (10 nm)

Protection film: Ru film (5 nm)

The method of forming the layered bodies of Example 2 is substantially the same as that of Example 1-1, and accordingly, a description thereof is omitted.

### Comparative Example 1

The layered bodies of Comparative Example 1 were configured substantially the same as those of Example 2 except for replacing the Ta film of Example 2 with a Cu film. The method of forming a magnetoresistive element of Comparative Example 1 is substantially the same as that of Example 1.

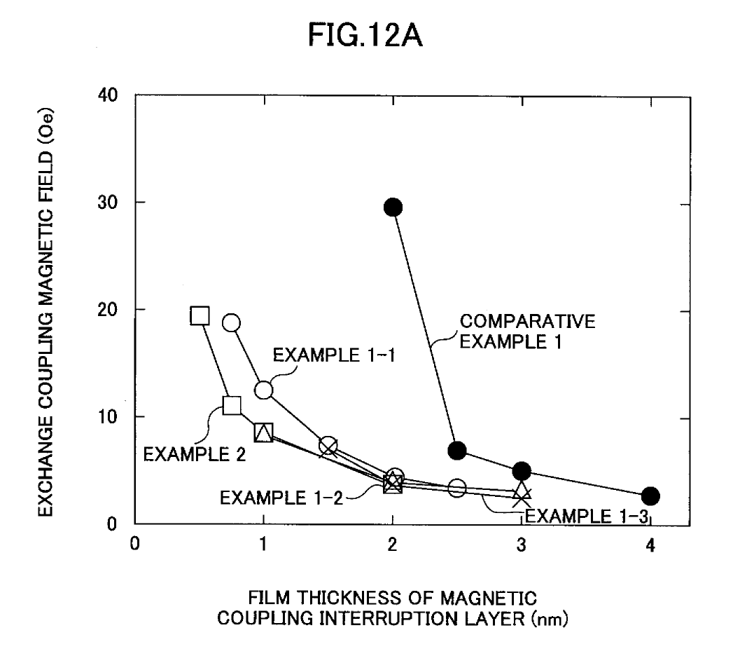

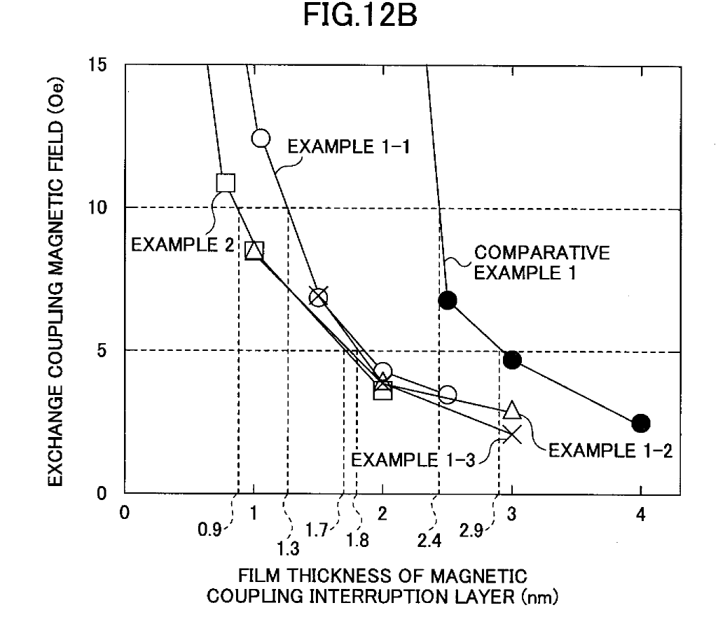

FIG. 12A is a graph showing the relationship between the exchange coupling magnetic field and the film thickness of the magnetic coupling interruption layer of each of Examples 1-1 through 1-3 and 2 and Comparative Example 1, and FIG. 12B is a graph scaling up the vertical axis of FIG. 12A.

In FIGS. 12A and 12B, the vertical axis shows the exchange coupling magnetic field of the first magnetic layer and the second magnetic layer, and the horizontal axis shows the sum of the film thicknesses of the first magnetic coupling interruption layer and the second magnetic coupling interruption layer if the first and second magnetic coupling interruption layers are provided, and shows the film thickness of the Ta film if only the Ta film is provided as a magnetic coupling interruption layer. In the following description, the layered body of the first magnetic coupling interruption layer and the second magnetic coupling interruption layer and the Ta film as a magnetic coupling interruption layer are each simply referred to as “magnetic coupling interruption layer” unless otherwise noted. Further, in FIGS. 12A and 12B, white circles indicate Example 1-1, triangles indicated Example 1-2, crosses indicate Example 1-3, squares indicate Example 2, and black circles indicate Comparative Example 1.

FIGS. 12A and 12B show that the ratio of an increase in the exchange coupling magnetic field of the first magnetic layer and the second magnetic layer accompanying reduction in the film thickness of the magnetic coupling interruption layer is less in Examples 1-1 through 1-3 and 2 than in Comparative Example 1. This shows that by using a Ta film as the second magnetic coupling interruption layers of Examples 1-1 through 1-3 and the magnetic coupling interruption layer of Example 2, it is possible to suppress the magnetic interaction between the free magnetization layer and the upper terminal of each example magnetoresistive element according to the first embodiment.

In Comparative Example 1, the Cu film needs to be 2.4 nm or more in film thickness in order that the exchange coupling magnetic field of the first magnetic layer and the second magnetic layer is 10 Oe or less. On the other hand, the magnetic coupling interruption layer needs to be 1.3 nm or more in Example 1-1 and 0.9 nm or more in Example 2. This shows that the magnetic coupling interruption layer can be reduced by 1.1 nm in Example 1-1 and 1.5 nm in Example 2. According to the studies made by the inventor of the present invention, it is confirmed that in actual use, the free magnetization layer of an actual magnetoresistive element is free of an adverse magnetic effect from the upper terminal if the exchange coupling magnetic field is 10 Oe or less.

Further, in Comparative Example 1, the Cu film needs to be 2.9 nm or more in film thickness in order that the exchange coupling magnetic field of the first magnetic layer and the second magnetic layer is 5 Oe or less. On the other hand, the magnetic coupling interruption layer needs to be 1.7 nm or 1.8 nm or more in film thickness in Examples 1-1 through 1-3 and 2. This shows that the magnetic coupling interruption layer can be reduced by 1.1 nm 15 in Examples 1-1 through 1-3 and 2.

Further, comparison of Examples 1-1 through 1-3 and 2 shows that the greater the proportion of the film thickness of the Ta film in the magnetic coupling interruption layer, the smaller the exchange coupling magnetic field, that is, Example 2 can reduce the exchange coupling magnetic field most.

### Example 3 and Comparative Example 2

In Example 3, magnetoresistive elements having the configuration of the magnetoresistive element 20 shown in FIGS. 2 and 3 according to the first embodiment were made, and their respective magnetoresistance ratios were measured. Example 3 has the object of measuring magnetoresistance ratios. Cu films were employed for the lower terminal and the upper terminal in the magnetoresistive elements of Example 3, which does not affect magnetoresistance ratios.

The configuration of Example 3 is as follows. The parenthesized numeric values show film thickness, which is the same in the following example.

Lower terminal: Cu film (300 nm)

Underlayer: Ta film (5 nm)/Ru film (5 nm)

Antiferromagnetic layer: IrMn film (5 nm)

First fixed magnetization layer: CO₉₀Fe₁₀ film (3 nm)

Non-magnetic coupling layer: Ru film (0.8 nm)

Second fixed magnetization layer: Co₉₀Fe₁₀ film (3 nm)

Non-magnetic metal layer: Cu film (4 nm)

Free magnetization layer: CO₉₀Fe₁₀ film (3 nm)

First magnetic coupling interruption layer: Cu film (varied from 1.0 nm to 2.0 nm)

Second magnetic coupling interruption layer: Ta film (5 nm)

Upper terminal: Cu film (300 nm)

The method of manufacturing the magnetoresistive elements of Example 3 and Comparative Example 2 is as follows. First, a lower terminal layer is formed on a silicon substrate having a thermal oxide film formed thereon by DC magnetron sputtering. Then, a layered body having the above-described composition and film thickness from the underlayer to the second magnetic coupling interruption layer was formed in an ultra-high vacuum (a vacuum of 2×10⁻⁶ Pa or below) atmosphere by DC magnetron sputtering without heating the substrate.

Next, the obtained layered body was subjected to magnetization fixing heat treatment. The conditions of the magnetization fixing heat treatment were a heating temperature of 300° C., a treatment time of 3 hours, and an applied magnetic field of 1952 kA/m.

Next, a mask was formed on the layered body thus obtained, which was then ground by ion milling, so that the shaped layered body as shown in FIG. 4B was made.

Next, the layered body thus obtained was covered with a silicon oxide film. Then, the protection layer was exposed by dry etching, and the upper terminal was formed so as to be in contact with the protection layer by DC magnetron sputtering.

Further, for comparison, a magnetoresistive element without the Cu film of the first magnetic coupling interruption layer was made (as Comparative Example 2). The method of manufacturing the magnetoresistive element of Comparative Example 2 is substantially the same as that of Example 3.

Next, in the measurement of magnetoresistance change ΔR, with the current value of sense current being 2 mA, an external magnetic field sweep was performed parallel to the magnetization direction of the second fixed magnetization layer within the range of −79 kA/m to 79 kA/m, and the voltage between the lower electrode and the upper electrode was measured with a digital voltmeter, thereby obtaining a magnetoresistance curve. Then, the magnetoresistance change ΔR was determined from the difference between the maximum value and the minimum value of the magnetoresistance curve. Then, the product of the magnetoresistance change ΔR and the joining area A of the magnetoresistive element was obtained, so that the magnetoresistance change per unit area ΔRA was determined. The magnetoresistance ratio is the ratio of the magnetoresistance change ΔRA to the element resistance R_{ALL} of the magnetoresistive element (ΔRA/R_{ALL}×100(%)).

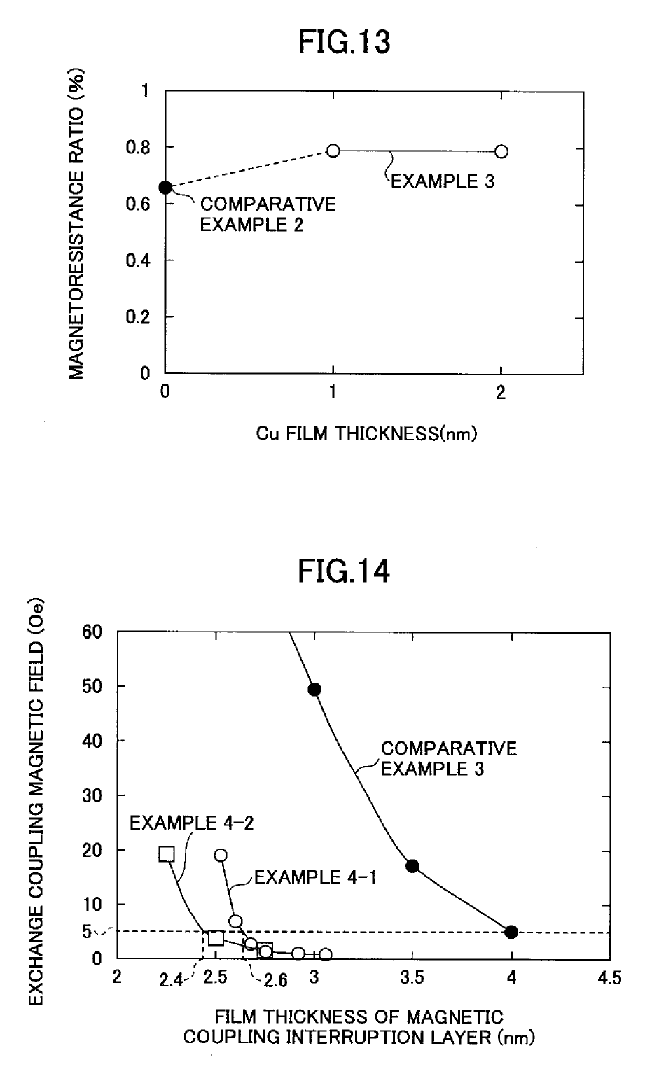

FIG. 13 is a graph showing the relationship between the magnetoresistance ratio and the film thickness of the first magnetic coupling interruption layer of each of Example 3 and Comparative Example 2. In FIG. 13, white circles indicate Example 3 and black circles indicate Comparative Example 2.

Referring to FIG. 13, the magnetoresistance ratio is 0.65% in Comparative Example 2 while the magnetoresistance ratio is 0.8% in Example 3. This shows that the magnetoresistance ratio is increased by approximately 20% by providing the first magnetic coupling interruption layer Cu film. This shows that by providing a Cu film as the first magnetic coupling interruption layer on the free magnetization layer, spin-dependent interface scattering increases so that the magnetoresistance ratio increases.

### Example 4

In Example 4 (Examples 4-1 and 4-2), layered bodies having the following configurations were made and their respective exchange coupling magnetic fields were measured in order to measure the degree of interruption of the exchange coupling magnetic field of the free magnetization layer 38 (shown in FIG. 3) and the upper terminal 22 by the first magnetic coupling interruption layer 25, the second magnetic coupling interruption layer 26, and the third magnetic coupling interruption layer 51 forming the magnetoresistive element 50 according to the first embodiment shown in FIG. 5. The forming method is substantially the same as that of Example 1, and accordingly, a description thereof is omitted.

### Example 4-1

The configuration of the layered bodies of Example 1-1 is as follows. The parenthesized numeric values show film thickness, which is the same in the following example.

Underlayer: Ta film (5 nm)/Ru film (5 nm)

Antiferromagnetic layer: IrMn (5 nm)

First magnetic layer: Ni₈₀Fe₂₀ (5 nm)

First magnetic coupling interruption layer: Cu film (1.0 nm)

Second magnetic coupling interruption layer: Ta film (varied from 0.5 nm to 1.1 nm)

Third magnetic coupling interruption layer: Cu film (1.0 nm)

Second magnetic layer: Ni₈₀Fe₂₀ (10 nm)

Protection film: Ru film (5 nm)

### Example 4-2

The layered bodies of Example 4-2 were configured the same as those of Example 4-1 except that the second magnetic coupling interruption layer was a Ru film and that the film thickness of the Ru film was varied from 0.25 nm to 0.75 nm.

### Comparative Example 3

The layered bodies of Comparative Example 3 were configured the same as those of Example 4-1 except that the first through third magnetic coupling interruption layers of Example 4-1 were replaced by a single Cu film and that the film thickness of the Cu film was varied from 3.0 nm to 4.0 nm.

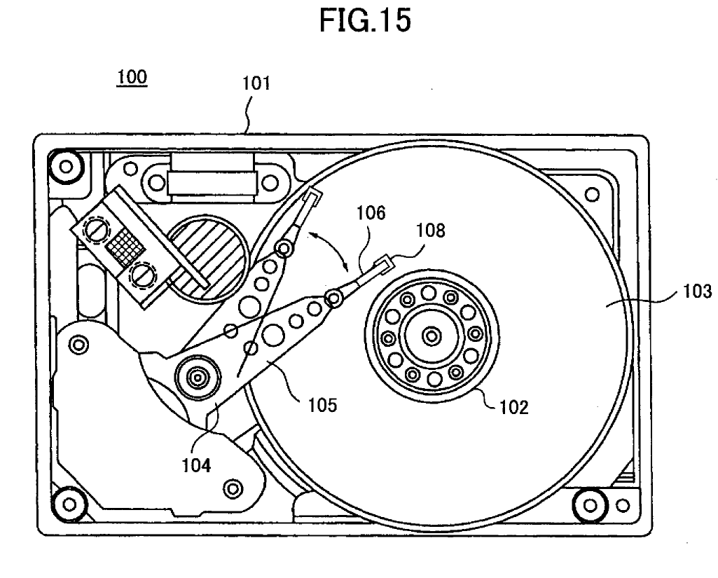

FIG. 14 is a graph showing the relationship between the exchange coupling magnetic field and the film thickness of the magnetic coupling interruption layer of each of Example 4 and Comparative Example 3. In FIG. 14, the vertical axis shows the exchange coupling magnetic field of the first magnetic layer and the second magnetic layer, and the horizontal axis shows the sum of the film thicknesses of the first through third magnetic coupling interruption layers. In the following description, the layered body of the first through third magnetic coupling interruption layers is simply referred to as “magnetic coupling interruption layer” unless otherwise noted. Further, in FIG. 14, white circles indicate Example 4-1, squares indicate Example 4-2, and black circles indicate Comparative Example 3.

FIG. 14 shows that the ratio of an increase in the exchange coupling magnetic field of the first magnetic layer and the second magnetic layer accompanying reduction in the film thickness of the magnetic coupling interruption layer is less in Examples 4-1 and 4-2 than in Comparative Example 3. This shows that by using a Ta film and a Ru film as the second magnetic coupling interruption layers of Examples 4-1 and 4-2, respectively, it is possible to suppress the magnetic interaction between the free magnetization layer and the upper terminal of the magnetoresistive element 50 according to the first embodiment.

Further, in Comparative Example 3, the Cu film needs to be 4.0 nm or more in film thickness in order that the exchange coupling magnetic field of the first magnetic layer and the second magnetic layer is 5 Oe or less. On the other hand, the magnetic coupling interruption layer needs to be 2.6 nm and 2.4 nm or more in film thickness in Examples 4-1 and 4-2, respectively. This shows that the magnetic coupling interruption layer can be reduced by 2.4 nm or more in Examples 4-1 and 4-2.

### Second Embodiment

FIG. 15 is a plan view of part of a magnetic storage unit 100 according to a second embodiment of the present invention.

Referring to FIG. 15, the magnetic storage unit 100 includes a housing 101. In the housing 101, a hub 102 driven by a spindle (not graphically illustrated), a magnetic recording medium 103 fixed to the hub 102 and rotated by the spindle, an actuator unit 104, an arm 105 and a suspension 106 supported by the actuator unit 104 so as to be driven in the radial directions of the magnetic recording medium 103, and a magnetic head 108 supported by the suspension 106 are provided.

The magnetic recording medium 103 may be of either a longitudinal magnetic recording type or a perpendicular magnetic recording type. Alternatively, the magnetic recording medium 103 may be one having oblique anisotropy.

The magnetic head 108 includes a magnetoresistive element (for example, the magnetoresistive element 20) formed on the ceramic substrate 11 and the induction-type recording element 13 formed thereon as shown in FIG. 2. The induction-type recording element 13 may be a ring-type recording element for longitudinal magnetic recording, a magnetic monopole recording element for perpendicular magnetic recording, or any other known recording element.

The magnetoresistive element of the magnetic head 108 may be any of the first through fifth example magnetoresistive elements 20, 50, 60, 70, and 75 of the first embodiment. Accordingly, the magnetoresistive element can suppress the magnetic interaction between the magnetoresistive film and each of the upper terminal and the lower terminal, and can reduce read gap length, so that it is possible to improve reproduction output and SN ratio at high recording density. As a result, the magnetic storage unit 100 is suitable for high-density recording. The basic configuration of the magnetic storage unit 100 according to the second embodiment is not limited to the one shown in FIG. 15.

The present invention is not limited to the specifically disclosed embodiments, and variations and modifications may be made without departing from the scope of the present invention.

For example, in the second embodiment, a description is given of the case of a disk magnetic recording medium. However, the present invention may also be applied to a magnetic tape unit employing a tape magnetic recording medium. Further, a description is given above of the magnetic head including a magnetoresistive element and a recording element by way of example. However, the present invention may also be applied to a magnetic head including only a magnetoresistive element and to a magnetic head including multiple magnetoresistive elements.

What is claimed is:

1. A magnetoresistive element in which a sense current is fed in a direction perpendicular to a film plane of a magnetoresistive film, the magnetoresistive element comprising:
a first terminal and a second terminal provided on first and second opposing surfaces, respectively, of the magnetoresistive film, the first and second terminals each being formed of a soft magnetic material;
the magnetoresistive film including a fixed magnetization layer, a non-magnetic metal layer, and a free magnetization layer stacked in this order from a side of the first terminal; and
a first magnetic coupling interruption layer covering the free magnetization layer, and a second magnetic coupling interruption layer covering the first magnetic coupling interruption layer, the first and second magnetic coupling interruption layers being provided between the magnetoresistive element and the second terminal,
wherein the first magnetic coupling interruption layer includes a first non-magnetic material causing spin-dependent interface scattering; and
the second magnetic coupling interruption layer includes a second non-magnetic material different from the first non-magnetic material, the second non-magnetic material containing at least one selected from the group consisting of Al, Ti, Cr, Mn, Zn, Nb, Mo, Ru, Rh, Pd, Ag, In, Hf, Ta, W, Ir, Pt, and Au.

2. The magnetoresistive element as claimed in claim 1, wherein the second magnetic coupling interruption layer includes a material having a greater resistivity than a Cu film.

3. The magnetoresistive element as claimed in claim 1, wherein the second magnetic coupling interruption layer includes a material having a resistivity of 10 μΩcm or more.

4. The magnetoresistive element as claimed in claim 1, wherein the first magnetic coupling interruption layer includes one of a pure metal selected from the group consisting of Cu, Al, Au, Ag, and Cr and a metal containing the pure metal.

5. The magnetoresistive element as claimed in claim 1, further comprising:
a third magnetic coupling interruption layer covering the second magnetic coupling interruption layer,
wherein the third magnetic coupling interruption layer includes one of a pure metal selected from the group consisting of Cu, Al, Au, Ag, and Cr and a metal containing the pure metal.

6. The magnetoresistive element as claimed in claim 1, further comprising:
a soft magnetic protection film covering the second magnetic coupling interruption layer,
wherein the soft magnetic protection film includes a soft magnetic material of one of a metal and an alloy.

7. The magnetoresistive element as claimed in claim 6, wherein the second terminal is in contact with a metal surface of the soft magnetic protection film.

8. The magnetoresistive element as claimed in claim 7, wherein an oxidized part is formed on a surface of the soft magnetic protection film on each of sides of the metal surface in contact with the second terminal in core width directions.

9. The magnetoresistive element as claimed in claim 1, wherein the second magnetic coupling interruption layer includes one of Ta and Ru.

10. A magnetoresistive element in which a sense current is fed in a direction perpendicular to a film plane of a magnetoresistive film, the magnetoresistive element comprising:
a first terminal and a second terminal provided on first and second opposing surfaces, respectively, of the magnetoresistive film, the first and second terminals each being formed of a soft magnetic material;
the magnetoresistive film including a fixed magnetization layer, a non-magnetic layer, and a free magnetization layer stacked; and
a magnetic coupling interruption layer provided between the magnetoresistive element and the second terminal,
wherein the magnetic coupling interruption layer includes Ta, and has a film thickness in a range of 0.9 nm to 5 nm.

11. The magnetoresistive element as claimed in claim 10, further comprising:
a soft magnetic protection film covering the magnetic coupling interruption layer,
wherein the soft magnetic protection film includes a soft magnetic material of one of a metal and an alloy.

12. The magnetoresistive element as claimed in claim 11, wherein the second terminal is in contact with a metal surface of the soft magnetic protection film.

13. The magnetoresistive element as claimed in claim 12, wherein an oxidized part is formed on a surface of the soft magnetic protection film on each of sides of the metal surface in contact with the second terminal in core width directions.

14. The magnetoresistive element as claimed in claim 10, wherein the non-magnetic layer includes a non-magnetic metal causing spin-dependent interface scattering between the non-magnetic layer and the free magnetization layer.

15. The magnetoresistive element as claimed in claim 10, wherein the non-magnetic layer includes a non-magnetic insulating material.

16. A method of manufacturing a magnetoresistive element in which a sense current is fed in a direction perpendicular to a film plane of a magnetoresistive film, the method comprising the steps of:
(a) forming the magnetoresistive film on a first terminal;
(b) forming a first magnetic coupling interruption layer and a second magnetic coupling interruption layer in this order on the magnetoresistive element, the first and second magnetic coupling interruption layers each including a non-magnetic material; and
(c) forming a second terminal in contact with a surface of the second magnetic coupling interruption layer,
wherein the first magnetic coupling interruption layer covers a free magnetization layer of the magnetoresistive film and includes a first non-magnetic material causing spin-dependent interface scattering; and
the second magnetic coupling interruption layer includes a second non-magnetic material different from the first non-magnetic material, the second non-magnetic material containing at least one selected from the group consisting of Al, Ti, Cr, Mn, Zn, Nb, Mo, Ru, Rh, Pd, Ag, In, Hf, Ta, W, Ir, Pt, and Au.

17. A method of manufacturing a magnetoresistive element in which a sense current is fed in a direction perpendicular to a film plane of a magnetoresistive film, the method comprising the steps of:
(a) forming the magnetoresistive film on a first terminal;
(b) forming a magnetic coupling interruption layer including a non-magnetic material, and a soft magnetic protection film including a soft magnetic material in this order on the magnetoresistive element;
(c) performing heat treatment on the magnetoresistive film, the magnetic coupling interruption layer, and the soft magnetic protection film;
(d) removing a part of the soft magnetic protection film; and
(e) forming a second terminal covering a surface of the soft magnetic protection film exposed by said step (d),
wherein the magnetic coupling interruption layer includes at least one selected from the group consisting of Al, Ti, Cr, Mn, Zn, Nb, Mo, Ru, Rh, Pd, Ag, In, Hf, Ta, W, Ir, Pt, and Au.

18. The method as claimed in claim 17, wherein the magnetic coupling interruption layer comprises a Ta film.

19. A magnetic storage unit, comprising:
a magnetic head including the magnetoresistive element as set forth in claim 1; and
a magnetic recording medium.

20. A magnetic storage unit, comprising:
a magnetic head including the magnetoresistive element as set forth in claim 10; and
a magnetic recording medium.
